(19) United States
(12) Patent Application Publication
(10) Pub. No.: US 2011/0048641 A1
(43) Pub. Date: Mar. 3, 2011

(54) METHOD FOR SEPARATING AND REMOVING DICING SURFACE PROTECTION TAPE FROM OBJECT TO BE CUT

(75) Inventors: Toshimasa SUGIMURA, Osaka (JP); Akinori Nishio, Osaka (JP); Kazuyuki Kiuchi, Osaka (JP)

(73) Assignee: NITTO DENKO CORPORATION, Osaka (JP)

(21) Appl. No.: 12/871,096

(22) Filed: Aug. 30, 2010

(30) Foreign Application Priority Data
Aug. 31, 2009 (JP) JP2009-200231

(51) Int. Cl. B32B 38/10

(52) U.S. Cl. 156/344

(57) ABSTRACT

The present invention is intended to provide a method for protecting a surface of an object to be cut from contamination due to the adhesion of dust and the like, including cutting scraps, by bonding a surface protection tape to the surface of the object to be cut, and cutting the surface protection tape together with the object to be cut in a dicing process and, after the dicing process, easily separating and removing the protection tape from individual chips. To this end, there is provided a method in which a dicing surface protection tape is bonded to a surface of an object to be cut, the tape is cut together with the object to be cut, and then the dicing surface protection tape is removed with the object to be cut inclined.

### BACKGROUND OF THE INVENTION

1. Field of the Invention

The present invention relates to a separation and removal method applied after an object to be cut is diced with a dicing surface protection tape bonded thereto in a process of dividing the object to be cut, including semiconductor wafers, into individual pieces (dicing).

2. Description of the Related Art

Conventionally, a circuit-formed surface of a wafer remains exposed in a process of dividing a wafer into individual pieces (hereinafter referred to as a dicing process) performed after a back-grinding process. Accordingly, it has been premised that cutting water and dust, such as cutting scraps, arising from wafer cutting during dicing adhere to the circuit-formed surface, thus contaminating the exposed circuit-formed surface of surfaces of an electronic component. Such contamination may cause the electronic component to become defective. In this case, a study is made to protect the electronic component from dust, such as cutting scraps, by bonding a protection tape to the circuit-formed surface of the wafer and dicing the wafer and the protection tape together. However, the conventional protection tape is difficult to separate and remove separately from the individual pieces of the wafer, and therefore, has not yet been put into practical use.

In addition, there has been a growing demand recently for reductions in the thickness and weight of semiconductor materials. Thus, a need has arisen to reduce the thickness of a semiconductor silicon wafer to 100 μm or less. Such a thin-film wafer is extremely fragile and liable to crack, however. For this reason, it has become increasingly difficult to separate and remove a protection tape from the wafer divided into individual pieces. Hence, methods for separating and removing the protection tape have been worked out, including bonding a separating tape to the protection tape and separating and removing the protection tape from an adherend simultaneously with the separation of the separating tape, and blowing air at the protection tape to separate and remove the tape by the force of air blow.

Japanese Patent Laid-Open No. 2003-197567 describes a method for preventing contamination resulting from cutting water, cutting scraps, and the like by bonding a protection tape to a circuit-formed surface of surfaces of an electronic component prior to dicing. Specifically, the patent document describes a method for contracting the protection tape, and then blowing air at the tape, and a method for bonding a separating tape to the protection tape and applying an external force to the separating tape, thereby separating and removing the protection tape together with the separating tape.

In addition, Japanese Patent Laid-Open No. 2006-196823 describes a method for facilitating removal by using a polyolefin film as the base material of a protection tape, and heating the protection tape at the time of removing the tape, thereby heat-shrinking the base material and warping the protection tape.

In this method, the protection tape is difficult to separate and remove in the absence of any trigger for the separation of the protection tape. That is, a trigger for separation is necessary in order to separate and remove the protection tape from an adherend. Consequently, there is the need for a protection tape in which a trigger for separation can be easily created. As a method for creating such a trigger for separation, it is conceivable to use a method for creating the trigger by applying a contraction-inducing stimulus, such as heating, described in the abovementioned patent document, thereby contracting the protection tape. Another conceivable method is creating the trigger for separation of the protection tape by using a protection tape formed by laminating a contractile layer and a restriction layer and applying a contraction-inducing stimulus, such as heating, to cause the protection tape to spontaneously roll up.

However, the transformation of the protection tape resulting from the abovementioned contraction, particularly heat shrinkage, causes not only warpage but also random shape distortions, such as rumples, in the protection tape. As a result, in the case of, for example, rumples, there arises a marginal gap between each protruding portion of the concave and convex portions of the rumples and a substrate. If some means for forcibly opening up the protection tape, for example, blowing air, is carried out by taking advantage of such a gap as a trigger, forces act on a boundary between the adhesive agent of the protection tape and an adherend (chip), so as to separate the protection tape and the adherend from each other. Consequently, the protection tape is separated and removed from the substrate, such as a semiconductor wafer, with resistance to adhesive force. Note that the separation and removal method for facilitating separation by using air is means applicable to not only such random shape distortions but also regular shape distortions which cause the protection tape to spontaneously curl up.

As described above, it has been possible to separate and remove the protection tape also in the conventional methods. However, as illustrated in FIG. 12, these methods are carried out subsequently to a dicing process, with the substrate placed level and a dicing surface protection tape for protecting a circuit-formed surface facing up. If separation and collection are performed under such conditions as described above, particularly in the case of blowing air, individual separated-off portions of the dicing surface protection tape are likely to be blown away, or glide, roll or bounce over surfaces of an object to be cut at that time. Consequently, the surfaces of the object to be cut may be contaminated or damaged.

In addition, the individual portions of the dicing surface protection tape that have rolled or bounced in this way may also roll over a dicing tape and a dicing ring, thus adhering onto the dicing tape and the dicing ring. Such adhered portions of the tape are difficult to separate off.

In such a state of the dicing tape to which cut-off portions of the protection tape have adhered, the stretching properties of portions of the dicing tape to which the cut-off portions have adhered change in a process of picking up the object to be cut, which has subsequently been turned into individual articles, by stretching the dicing tape. Thus, it is no longer possible to stretch the dicing tape as a whole as intended.

Consequently, the positions of respective articles having widened array pitches thereamong no longer correspond to intended positions. Accordingly, in an apparatus for automatically picking up the articles, a pick-up jig fails to precisely have contact with the articles at preset positions and cannot unfailingly pick up the articles. As a result, defective articles arise for the reason that, for example, a positional relationship between the pick-up jig and the object to be cut goes out of order.

In addition, a method for separating and removing a dicing surface treatment tape by using a separating tape has the potential problem that there arise unseparated portions of the tape or the separating tape comes into contact with the object to be cut, unless the height of the dicing surface treatment tape is uniform. Another problem is that separation using tweezers is manual work and is, therefore, not efficient.

An object of the present invention is to provide a separation and removal method in which a surface protection tape is previously bonded to a surface of an object to be cut, and the surface protection tape is cut together with the object to be cut in a dicing process, thereby protecting the surface of the object to be cut from contamination due to the adhesion of dust and the like, including cutting scraps, and then reliably separating and removing portions of the protection tape bonded to the surface of the object to be cut and cut off together with the object to be cut, in a dicing process in which the protection tape is easily separated and removed from individual chips on the protection tape, and thereby preventing cut-off portions of the protection tape from contaminating the object to be cut, a dicing tape, and a dicing ring, and consequently preventing the cut-off portions of the protection tape from adversely affecting a pick-up process.

### SUMMARY OF THE INVENTION

A method of the present invention whereby the aforementioned object is achieved is designed so that a dicing surface protection tape which develops easy peeling properties by stimulation is bonded to one surface of an object to be cut to form a composite body, and then the composite body is positioned so that the dicing surface protection tape side faces up, the object to be cut is cut from the dicing surface protection tape side and, subsequently, A. a step of applying a stimulus to the dicing surface protection tape to cause the tape to develop easy peeling properties, B. a step of inclining the composite body at an arbitrary angle up to an angle for the composite body to turn over, and C. a step of separating and removing only the cut-off portions of the dicing surface protection tape from the composite body are carried out in the order of steps A to C, or in the order of steps B, A and C, or steps A and C are simultaneously carried out after step B to separate and remove the dicing surface protection tape from the object to be cut, or the dicing surface protection tape which develops easy peeling properties by stimulation is bonded to one surface of the object to be cut to form the composite body, and then the composite body is positioned so that the dicing surface protection tape side faces down, or the composite body is positioned at an arbitrary orientation, the object to be cut is cut from the dicing surface protection tape side, and, subsequently, A. a step of applying a stimulus to the dicing surface protection tape to cause the tape to develop easy peeling properties, and C. a step of separating and removing only the cut-off portions of the dicing surface protection tape from the composite body are carried out in the order of steps A and C, or steps A and C are simultaneously carried out to separate and remove the dicing surface protection tape from the object to be cut.

In addition, in such a method as described above, the step B may be carried out using a robot arm, a rotational axis provided in a composite body-retaining apparatus, or a reversing apparatus for sheet-like objects. Stimulation for the dicing surface protection tape to develop easy peeling properties is achieved by at least one of means, among bringing the tape into contact with a heated gas heat medium, bringing the tape into contact with a heated liquid heat medium, bringing the tape into contact with a heated solid heat medium, and irradiating the tape with infrared rays. Specifically, the means include: blowing heated air or a heated nitrogen gas or spraying heated water at the tape; immersing the tape in a vessel containing heated air, a heated nitrogen gas, or heated water; irradiating the tape with infrared rays by using an infrared lamp, an infrared laser, or an infrared LED; heating the tape by using a plate heater, a band heater, a ribbon heater, or the like; and irradiating the tape with ultraviolet rays or electromagnetic waves.

Subsequently-used means for separating and removing the protection tape is means for suctioning or blowing off the tape by a difference in atmospheric pressure. At that time, it is possible to concomitantly use flexible resin balls and, additionally, vibrate the tape from the rear surface of the object to be cut by using an ultrasonic transducer or the like.

Furthermore, the above-described method may be a method in which the dicing surface protection tape, which develops easy peeling properties by stimulation, has easy peeling properties as the result that the tape contracts by stimulation, a foaming agent-containing adhesive agent layer of the tape foams, or the tape curls up. In addition, the object to be cut may be one of a semiconductor wafer, a glass plate, and a resin plate.

In a method for separating and removing a surface protection tape according to the present invention, the object to be cut is inclined or turned over when the tape is bonded to a surface of the object to be cut and cut together therewith and is subsequently separated off and collected, the separated-off portions of the tape are transferred so as to move away from the surface of the object to be cut. Accordingly, the method prevents the separated-off portions of the tape from adhering to and contaminating a dicing tape and a dicing ring and, consequently, adversely affecting a pick-up process. In addition, in cases where there is adopted, as the dicing surface protection tape, a tape which is urged by the bonding of the tape at the time of cutting, so as to spontaneously curl up to form a cylindrical roll or rolls, while separating from an adherend in one direction from an end or ends of the tape (one end or opposed two ends) toward normally a main axis of contraction, it is possible to extremely easily separate and remove the tape from a surface of the adherend, without causing any damage to the adherend and contaminating the adherend due to incomplete separation. Thus, the method protects surfaces of the object to be cut from contamination due to the adhesion of dust and the like, including cutting scraps, in a dicing process, and is free from the possibility that such cylindrical rolls adhere to the dicing tape and the like and cause problems in a later pick-up process. Accordingly, the dicing surface protection tape is especially useful as a surface protection tape to be bonded to fragile adherends.

### BRIEF DESCRIPTION OF THE DRAWINGS

FIG. 1 is a schematic view illustrating one example of a method for separating and removing a surface protection tape of the present invention;

FIG. 2 is a schematic view illustrating another example of the method for separating and removing a surface protection tape of the present invention;

FIG. 3 is a schematic cross-sectional view illustrating one example of a laminated body 10 of a surface protection tape used in the present invention;

FIG. 4 is a schematic cross-sectional view illustrating one example of a laminated body 11 of a surface protection tape used in the present invention;

FIG. 5 is a schematic cross-sectional view illustrating one example of a laminated body 12 of a surface protection tape used in the present invention;

FIG. 6 is a schematic cross-sectional view illustrating one example of a laminated body 13 of a surface protection tape used in the present invention;

FIG. 7 is a schematic cross-sectional view illustrating one example of a laminated body 14 of a surface protection tape used in the present invention;

FIG. 8 is a schematic cross-sectional view illustrating one example of a laminated body 15 of a surface protection tape used in the present invention;

FIG. 9 is a schematic view illustrating one example of the way in which a surface protection tape used in the present invention curls up spontaneously;

FIG. 10 is a schematic view illustrating one example of the way in which a surface protection tape used in the present invention curls up spontaneously after being bonded to an adherend and diced together therewith;

FIG. 11 is a flowchart illustrating one example of a flow of chip formation using a method of surface protection tape separation and removal of the present invention; and

FIG. 12 is a schematic view illustrating a conventional method of surface protection tape separation and removal.

### DETAILED DESCRIPTION OF THE PREFERRED EMBODIMENTS

A method of surface protection tape separation and removal of the present invention is designed so that a dicing surface protection tape, which develops easy peeling properties by stimulation, is bonded to one surface of an object to be cut to form a composite body, and then the composite body is diced from a side of the object to be cut to which the dicing surface protection tape is bonded and the individual cut-off portions of the dicing surface protection tape are separated and removed from a surface of the object to be cut with the composite body inclined at an arbitrary angle, thereby reliably separating and removing the dicing surface protection tape cut and caused to develop easy peeling properties and powdery substances produced at the time of cutting the tape, the object to be cut, and the like, from the object to be cut.

In the present invention, examples of the object to be cut include general types of objects which have conventionally been subjected to a dicing process, such as a semiconductor wafer, glass, ceramics, and semiconductor-sealing resin. Of these objects, the semiconductor wafer, such as an 8-inch silicon mirror wafer, is preferably used. The post-cutting size of the object to be cut is preferably 10 mm×10 mm or smaller.

The base material of the dicing surface protection tape may be a heat-shrinkable film formed by uniaxially or biaxially stretching a heretofore-known single-layer or multilayer resin film.

A tackiness agent layer to be provided in this base material may be a layer of a heretofore-known rubber-based or acrylic-based tackiness agent, or a layer of a tackiness agent containing a heretofore-known filler or various heretofore-known additives. Alternatively, it is also possible to use a gas-generating agent-containing tackiness agent which is caused to develop easy peeling properties by containing therein a gas-generating agent, such as an azide compound or an azo compound, so that the tackiness agent layer becomes porous as the result of the gas-generating agent being decomposed by heating so as to generate a gas, thereby causing the tackiness agent layer and the surfaces thereof to be so irregular as to reduce the area of contact with the object to be cut. Still alternatively, it is also possible to use, for example, a gas-containing microcapsule-containing tackiness agent which is caused to develop easy peeling properties by containing gas-containing microcapsules in the tackiness agent, so that the tackiness agent layer becomes porous as the result of the microcapsules being destroyed by heating while in use, so as to spread the contained gas within the tackiness agent layer, thereby enabling the same mechanism as that of the abovementioned gas-generating agent-containing dicing surface protection tape to work.

Still alternatively, it is also possible to use a heretofore-known tackiness agent which decreases in tackiness and develops easy peeling properties as the result of being hardened by the formation of a three-dimensional mesh structure due to irradiation with activated energy lines, such as ultraviolet rays. As the tackiness agent, it is possible to use a tackiness agent composite, such as a rubber-based tackiness agent; a silicone-based tackiness agent; or an acrylic-based tackiness agent, formed by using a rubber-based polymer, such as heretofore-known natural rubber, polyisobutylene rubber, styrene-butadiene rubber, styrene-isoprene-styrene block copolymer rubber, reclaimed rubber, butyl rubber, polyisobutylene rubber or NBR, as a base polymer and compounding various widely-known additives, in which resin composing the tackiness agent composite is chemically modified with a carbon-carbon multiple bond-containing reactive group, or compounded with a monomer or a polymer having a reactive group, such as a poly (meth)acryloyl group.

Tackiness necessary for these tackiness agents is 6.5 N/10 mm or less (for example, 0.05 to 6.5 N/10 mm, preferably 0.2 to 6.5 N/10 mm) and, in particular, 6.0 N/10 mm or less (for example, 0.05 to 6.0 N/10 mm, preferably 0.2 to 6.0 N/10 mm), before and after processing for reduction in tackiness, in a 180° peel test (room temperature (25° C.)) using a silicon mirror wafer as an adherend. The thickness of a tackiness agent layer is generally 10 to 200 μm, preferably 20 to 100 μm, and more preferably 30 to 60 μm. If the above-mentioned thickness is too small, the tackiness is insufficient, thus tending to cause difficulty in holding or temporarily fixing the adherend. If the above-mentioned thickness is too large, the protection tape is uneconomical and inferior in handleability and is therefore not preferable.

Processing for reduction in tackiness needs to be performed as necessary, to the extent that the protection tape has the above-described tackiness properties. Subsequently or concurrently, the base material of the dicing surface protection tape needs to be contracted by stimulation.

The stimulation refers to processing by energization means, such as heating or infrared irradiation, necessary to cause the bonded dicing surface protection tape to have easy peeling properties. Specifically, it is possible to use optional heating means, including blow of heated air, immersion in a liquid, such as heated water, or heating by an infrared lamp, an infrared laser, an infrared LED, a plate heater, a band heater or a ribbon heater, or irradiation means using an ultraviolet lamp, microwaves or the like. Heating temperature is such temperature as not to adversely affect the properties of an object to be cut, and is 50° C. or higher, preferably 50° C. to 180° C., and more preferably 70° C. to 180° C. Irradiation using an ultraviolet lamp or microwaves is likewise performed to the extent that the amount of irradiation energy does not adversely affect the properties of the object to be cut. That is, the processing is performed to the extent that the dicing surface protection tape, particularly the adhesive agent layer thereof, is decreased in tackiness by means of cross-linkage or decomposition, so as to be able to have easy peeling properties. Note that when the abovementioned means of immersion in heated water or the like is adopted, there arises the need for a process utilizing drying means for drying the protection tape thereafter.

As described above, each of these dicing surface protection tapes is required to form at least a marginal gap between the protection tape and the object to be cut, after being stimulated, in order to promote the facilitation of a subsequent removal process.

As any of these dicing surface protection tapes, it is possible to use a dicing surface protection tape in which a shrinkable film layer having contractility at least in a uniaxial direction and a restriction layer for restricting the contractility of the shrinkable film layer are preferably laminated, so that the protection tape separates off upon application of a contraction-inducing stimulus, while spontaneously curling up in one direction from one end of the tape or toward the center of the tape from opposed two ends, thereby forming one or two cylindrical rolls.

In the present invention, a process of inclining the object to be cut at an arbitrary angle from beyond 0° up to an angle for the object to turn over is a process in which an inclination in a state in which the object to be cut is placed on a level plane in a dicing process and the dicing surface protection tape bonded onto the upper surface of the object is diced, that is, a state in which the object to be cut is placed horizontally and the upper surface thereof is protected by the bonded dicing surface protection tape is defined as 0°, and an inclination from the level plane when this object to be cut is inclined is defined as the abovementioned angle. In addition, a state in which the dicing surface protection tape bonded to the lower surface of the horizontal object to be cut is inclined at 180° is defined as a state of the object at an angle of 0° being turned over. Accordingly, in the present invention, a process of inclining the object to be cut at an arbitrary angle from beyond 0° up to an angle for the object to turn over is a process of inclining the object at an arbitrary angle from a state in which the object is slightly inclined from 0° up to a state in which the object is turned over.

In the present invention, dicing is performed after this dicing surface protection tape is bonded to an adherend. As a dicing apparatus and a dicing method, a heretofore-known method may be optionally selected and adopted. In addition, it is possible to adopt a process in which spraying of water or blowing of a gas at cutting sites is concomitantly used at the time of dicing. Thus, there are no restrictions arising from the use of the dicing surface protection tape. Note that if the adherend is a semiconductor wafer, a back-grinding process is performed after the dicing surface protection tape is bonded to the adherend, and a dicing process may be performed directly without separating and removing the tape.

The dicing process is generally performed with a composite body positioned at an angle of 0°, i.e., with the object to be cut, to the upper surface of which the dicing surface protection tape is bonded, positioned horizontally. In the present invention, however, the dicing process can also be performed with the composite body inclined. In addition, the angle of inclination may be such that the composite body is positioned upright, i.e., 90°. Alternatively, the composite body may be inclined to 180°, i.e., turned over, so that the dicing surface protection tape faces down, and then dicing may be performed.

In the present invention, as means for inclining the object to be cut, it is possible to adopt means in which a member, such as a frame-like object for supporting the object to be cut, a plate-like object, an arm, or the like, is connected to a rotational axis driven by a separate driving unit, and the object to be cut is inclined together with the member by rotating this rotational axis. Alternatively, it is also possible to adopt, for example, means for letting a robot arm or the like hold the object to be cut together with the member and rotating this robot arm, or means for mounting the object to be cut, together with the member, in heretofore-known means for turning over sheet-like objects. Still alternatively, it is also possible to incline the object to be cut by using a heretofore-known apparatus for adjusting workpiece positions.

If the composite body is inclined as described above, cut-off portions of the dicing surface protection tape, even though allowed to roll over the object to be cut, will roll over according to the inclination. Thus, it is possible to prevent the cut-off portions from adhering to surfaces of a dicing tape. In addition, if the composite body is inclined to 90° or greater, the cut-off portions of the dicing surface protection tape no longer roll over a surface of the object to be cut, though the cut-off portions may simply drop. Thus, the cut-off portions do not adhere to surfaces of a dicing tape, a dicing ring and the like. For such reasons, the present invention can exert the above-described advantageous effects by separating and removing the dicing surface protection tape cut with the object to be cut inclined.

As means for separating and removing the dicing surface protection tape in the present invention, it is possible to adopt means which uses an apparatus capable of suctioning or blowing off the tape by a difference in atmospheric pressure, means which concomitantly uses resin particles along with the blowing-off means to take advantage of the kinetic energy of the resin particles as energy for separating and removing the tape, means which utilizes static electricity to adsorb the tape, or the like. At that time, it is possible to concomitantly use the application of ultrasonic transducer-induced vibrations from the rear surface of the object to be cut. If the means for blowing off the tape by a difference in atmospheric pressure is adopted, it is possible to separate and remove the surface protection tape by blowing it off, while applying a stimulus to the tape by using a heated gas.

Specific examples of the means which uses an apparatus capable of suctioning and/or blowing off the tape by a difference in atmospheric pressure include blowing a gas by using various types of air cleaners, blowers, and the like, suctioning the tape by a nozzle connected to a vacuum apparatus or the like, and blowing a gas at the tape or suctioning the tape by the concomitant use of these apparatus.

The blow-off and suction strengths of these means may be set optionally to the extent of enabling separation and removal according to the present invention. However, the strengths have to be at such levels as not to destroy the object to be cut or change the physical properties thereof. When blowing a gas at the tape, there is the need to consider, for example, a direction in which the gas is blown, in order to prevent cut-off portions of the dicing surface protection tape and powdery particulates from flying off, adhering to a dicing tape and a dicing ring, and consequently causing problems in a subsequent pick-up process or contaminating chips.

Accordingly, it is desirable to not only simply blow a gas by using an air cleaner or a blower, but also place a suction nozzle for suctioning the gas, in some cases, in a position where the blown-off gas is collected together with the separated-off portions of the surface protection tape.

In addition, the gas has to be forcibly blown into between the object to be cut and the dicing surface protection tape, so that, as the result of the gas being blown at the ends of the cut-off portions of the dicing surface protection tape bonded to the object to be cut, the tape ends separate from the object to be cut. Therefore, the angle at which the gas is blown with respect to a surface of the object to be cut needs to be sufficiently small. Otherwise, the blown gas behaves so as to hold down the dicing surface protection tape on the object to be cut, and therefore, the tape may not be fully separated off.

Furthermore, if means based on a liquid such as heated water is adopted as the stimulus for imparting peeling properties to the dicing surface protection tape, the means can also serve as drying means to be used later in a process of blowing the gas to separate and remove the tape.

If the cut-off portions of the dicing surface protection tape on the object to be cut are of such a nature as to merely shrink by stimulation or develop peeling properties due to reduction in tackiness caused by gas generation or the like, it is generally uncertain toward which direction, the tape especially exhibits easy peeling properties, or toward which direction, the tape has particularly large gaps with respect to a surface of the object to be cut, after shrinkage, gas generation, or the like. When blowing and/or suctioning a gas for the purpose of separation and removal, it is possible to more reliably separate and remove the dicing surface protection tape by blowing or suctioning the gas from multiple directions, rather than blowing the gas against the object to be cut from one direction only. Furthermore, it is possible to even more reliably remove microscopic particles, which are produced during cutting and present in gaps among portions of the object to be cut which has been cut into a grid-like shape, by means of multidirectional blowing.

By mixing flexible resin balls with a stream of blown gas and bombarding the resin balls against the object to be cut and the dicing surface protection tape, it is also possible to facilitate the separation of the tape through the utilization of the kinetic energy of the resin balls. Care should be taken, however, not to destroy the object to be cut or adversely affect the physical properties thereof through the use of the resin balls. If the resin balls adhere to a dicing tape or a dicing ring, the resin balls may adversely affect a subsequent pick-up process, thus failing to achieve the object of the present invention. Accordingly, care should also be taken in this regard.

Accordingly, the resin balls have such flexibility as not to adversely affect the object to be cut. In addition, all of the blown-off resin balls are collected by fully suctioning the gas concurrently with blowing the gas. Resin balls available for such a purpose of use need to be, for example, sponge-like, porous and flexible, or sufficiently flexible as a whole, though not porous. The resin balls also need to have the nature of not adhering to the object to be cut due to tackiness, electrostatic force caused by electrification, or the like.

In addition, vibrations may be applied to the dicing surface protection tape by periodically or non-periodically increasing and decreasing blowing strength at the time of blowoff. This method widens a gap between an end of the dicing surface protection tape and the object to be cut, thereby enabling further facilitation of separation and removal.

In these cases, the gas used to blow may be air, nitrogen gas, or the like. Alternatively, heated air, nitrogen gas or the like can also be used. In this case, it is possible to cause the dicing surface protection tape to shrink and curl up, as described above, in order to allow the tape to have easy peeling properties. It is possible to cause the dicing surface protection tape to be separated off and removed by the gas blown at the tape while causing a tackiness agent layer to foam due to heating. For example, stimulation by heating and separation may be performed concurrently by blowing heated air at a surface of the dicing surface protection tape in order, beginning with a certain part of the surface.

A suction force applied to this tape is made stronger by bringing a suction nozzle as close as possible to the object to be cut when suctioning the dicing surface protection tape. Thus, it is possible to reliably separate and remove the tape. In addition, a spiral groove, for example, may be provided inside the leading end of a nozzle, so that the nozzle has a structure capable of forming vortex flows, thereby further strengthening the suction force.

If adsorption means utilizing static electricity is adopted, a side surface of an electrified roller-like or rod-like object or a front surface of a brush is moved alongside a surface of the dicing surface protection tape of the object to be cut across the entire surface thereof. Such an operation is repeated twice or more times. In second and subsequent operations, an object whose polarity of static electricity has been reversed may be moved along the surface of the object to be cut. If the brush is made of a flexible material, it is also possible to remove the surface protection tape by bringing the brush into contact with the surface of the object to be cut, so as not to cause any damage thereto.

In this case, setting a potential difference with respect to the object to be cut to too large a value may change the properties of the object to be cut. In contrast, setting the potential difference to too small a value may fail to sufficiently separate and remove the dicing surface protection tape. Therefore, full consideration needs to be given to the potential difference. Accordingly, it is also possible to previously electrify the object to be cut, while taking into account the potential of the electrified roller or the like.

In addition, cleaning utilizing static electricity produces a removal effect even if objects to be removed are small. Therefore, the cleaning may be performed subsequently to the abovementioned separation and removal process utilizing an atmospheric pressure, in order to remove microscopic particles present among individual pieces of the object to be cut.

Furthermore, in addition to these means for separating and removing the dicing surface protection tape, the object to be cut may be vibrated using an ultrasonic transducer or the like to transmit the vibrations to bonded portions of the dicing surface protection tape and microscopic particles, thereby forming a gap between the dicing surface protection tape and the object to be cut. Alternatively, a gas may be blown, while separating the surface protection tape and the object to be cut from each other, so as to widen the gap. The dicing surface protection tape can thus be separated and removed as well.

However, if the ultrasonic transducer is vibrated in contact with the object to be cut, the object to be cut may be destroyed by the vibration. Accordingly, consideration is required of vibrational power and a method of contact with the object to be cut. In addition, even if the ultrasonic transducer is brought into contact with any single point of the object to be cut, the object to be cut may be destroyed from the contact point. It is therefore preferable, from the viewpoint of uniform vibrations being applied to the entire range of the object to be cut, to previously form another layer capable of dispersing vibrations, between the ultrasonic transducer and the object to be cut, in addition to a dicing sheet or the like.

It is more preferably to use, as the above-mentioned dicing surface protection tape, a dicing surface protection tape in which a shrinkable film layer having contractility at least in a uniaxial direction and a restriction layer for restricting the contractility of the shrinkable film layer are laminated, so that the protection tape separates off upon application of a contraction-inducing stimulus, while spontaneously curling up in one direction from one end of the tape or toward the center of the tape from opposed two ends to form one or two cylindrical rolls, in combination with a process of inclining a composite body of the present invention at an arbitrary angle up to an angle for the composite body to turn over. In addition, this dicing surface protection tape has the following properties, shapes, and the like:

The abovementioned cylindrical roll is not limited to a roll the both ends of which overlap with each other to form a completely rolled-up cylindrical shape, but includes rolls in which the both ends of the tape remain separated without overlapping with each other to form a cylindrical shape whose part of the side surface is open. Preferably, the both ends of the tape overlap with each other, so that the tape is in a state of having completely rolled up into a cylindrical shape.

The dicing surface protection tape, which separates off while forming a cylindrical roil or rolls, draws an arc after having rolled up, and is in abutting contact with a surface of the object to be cut across, for example, a single line segment. Note that in the present specification, the phrase “spontaneously curls up” means that the tape is caused to separate from the adherend by itself by simply applying a contraction-inducing stimulus to the tape, without using hands or the like, thereby, for example, making a trigger for separation available.

The dicing surface protection tape which separates off while forming a cylindrical roll or rolls preferably separates off from the object to be cut, while spontaneously curling up in one direction from one end of the tape or toward the center thereof from opposed two ends by heating, thereby forming one or two cylindrical rolls.

A temperature at which the tape spontaneously separates off, for example, an upper temperature limit is not limited in particular, as long as the temperature, for example, allows the tape to curl up without affecting the object to be cut. For example, the temperature can be set to 50° C. or higher, preferably 50° C. to 180° C., and more preferably 70° C. to 180° C.

In the dicing surface protection tape which separates off while forming a cylindrical roll or rolls, the restriction layer is preferably formed of an elastic layer on the shrinkable film layer side and a rigid film layer on a side opposite to the shrinkable film layer side. In addition, the surface protection tape of the present invention preferably further includes a tackiness agent layer, and the tackiness agent layer preferably includes an activated energy line (for example, UV)-hardening tackiness agent.

As the dicing surface protection tape which separates off while forming a cylindrical roll or rolls, a shrinkable film layer/restriction layer laminated body is used. Preferably, it is possible to use a shrinkable film layer/elastic layer/rigid film layer/tackiness agent layer laminated body (hereinafter, these laminated bodies may be referred to as self-rolling tapes). With this composition, contraction stress is converted into force couple, thereby causing the tape to reliably transform into a cylindrical roll or rolls after the application of a contraction-inducing stimulus. This makes tape removal in a later separation process extremely easy and convenient. Note that details on the materials and the like composing the tape may be compliant with those of U.S. Pat. No. 4,151,850. Specifically, the tape is preferably a laminated body (self-rolling tape) comprised of a shrinkable film layer, an elastic layer, a rigid film layer and a tackiness agent layer.

As the method of the present invention, a method for separating and removing a dicing surface protection tape which separates off while forming a cylindrical roll or rolls preferably includes the steps of: bonding a dicing surface protection tape in which a shrinkable film layer bonded to a surface of an object to be cut and having contractility at least in a uniaxial direction and a restriction layer for restricting the contractility of the shrinkable film layer are laminated;

cutting the object to be cut with the dicing surface protection tape bonded thereto;

applying a contraction-inducing stimulus to the cut-off portions of the dicing surface protection tape bonded to surfaces of the cut-off portions of the object to be cut to cause each of the cut-off portions of the dicing surface protection tape to curl up in one direction from one end of the tape or toward the center thereof from two opposed ends, thereby forming one or two cylindrical rolls;

inclining the composite body at an arbitrary angle up to an angle for the composite body to turn over; and

separating and removing portions of the dicing surface protection tape bonded to surfaces of the individual cut-off portions of the object to be cut,

wherein the step of inclining the composite body at an arbitrary angle up to an angle for the composite body to turn over is provided at any stage, from a stage preceding the step of cutting the object to be cut to a stage preceded by the step of causing each of the cut-off portions of the dicing surface protection tape to curl up in one direction from one end of the tape or toward the center thereof from two opposed ends, thereby forming one or two cylindrical rolls.

More preferably, unlike a conventional method (without the use of a protection tape) in which a process is advanced to a step of collecting (picking up) diced pieces of an adherend after dicing, the method for separating and removing the surface protection tape of the present invention first performs either the step of inclining the object to be cut and the dicing surface protection tape at an arbitrary angle up to an angle for the object and the tape to turn over or the step of applying a contraction-inducing stimulus, such as heating, to the dicing surface protection tape after dicing, and then performs the other step, followed by the step of separating and removing the tape (separation and removal process).

In the method for separating and removing the dicing surface protection tape which separates off while forming a cylindrical roll or rolls, the contraction-inducing stimulus is preferably heating. In addition, the method preferably further includes a step of irradiating activated energy lines prior to or simultaneously with the heating.

Such a separation and removal process includes: a. a step of performing UV irradiation (if the tackiness agent layer is a UV-hardening tackiness agent layer); b. a step of performing application of a contraction-inducing stimulus to transform the tape into a cylindrical roll or rolls; and c. a step of removing the transformed tape from the adherend, and, most preferably, proceeds in the order of steps a, b and c. Alternatively, these steps may be carried out at the same time.

A method used in step a may be a heretofore-known method. That is, an exposure dose of approximately 500 to 1000 mJ/cm² of light in a UV wavelength band may be irradiated to the tape by using a high-pressure mercury lamp, a xenon lamp, an ultraviolet LED or the like as a light source.

As a method for applying a contraction-inducing stimulus in step b, it is possible to use a method preferably capable of heating, as well as capable of using a heat source, such as a hot plate, a heat gun or an infrared lamp, for the heating. Thus, an appropriate method is selected and used, so that a temperature, at which the transformation of the tape takes place without delay, is reached. A heating temperature, for example, an upper temperature limit is not limited in particular, as long as the temperature allows the tape to curl up without affecting the object to be cut. For example, the temperature can be set to 50° C. or higher, preferably 50° C. to 180° C., and more preferably 70° C. to 180° C. Note that the contraction-inducing stimulus may be applied uniformly to allow all portions of the tape to transform. Alternatively, the contraction-inducing stimulus may be applied spotwise. For example, a method may be used in which the tape is partially heated and transformed at an optional position thereof by using a spot-heating apparatus or the like.

Possible methods for use in step c include blowing an airstream to blow off the transformed tape, suctioning the tape with a vacuum cleaner, and adsorbing the tape by means of electrostatic force. Note that if a separating tape is used, it is necessary to contrive a bonding method, so that the separating tape does not come into contact with a surface of an adherend (see referential examples to be described later).

The separation process preferably includes: a heating step using a heating apparatus and a heating method (hot plate, heat gun or the like) for transforming the tape; and a removal step using a method of post-heating protection tape removal (blowing off, suctioning, bonding a separating tape, or the like). Preferably, the tape is heated in the heating step using any one of a hot plate, a heat gun and an infrared lamp, or a combination thereof.

Preferably, the surface protection tape is removed in the removal step by means of either blowoff using an airstream or suction and removal by attraction, or by a combination thereof. The suction and removal is preferably performed using a vacuum cleaner or the like. Note here that a heated airstream may be used at the time of blowoff using an airstream. This means that both the abovementioned separation step and removal step are simultaneously carried out, thereby enabling efficient removal.

Hereinafter, embodiments of the present invention will be described with reference to the accompanying drawings by citing examples in which a dicing surface protection tape which separates off while forming a cylindrical roll or rolls is used. The methods described below are not limited to a dicing surface protection tape which forms a cylindrical roll or rolls. The separation and processing means and the materials used for a tackiness agent layer and a shrinkable film layer composing the dicing surface protection tape can be used for various types of dicing surface protection tapes in the methods of the present invention.

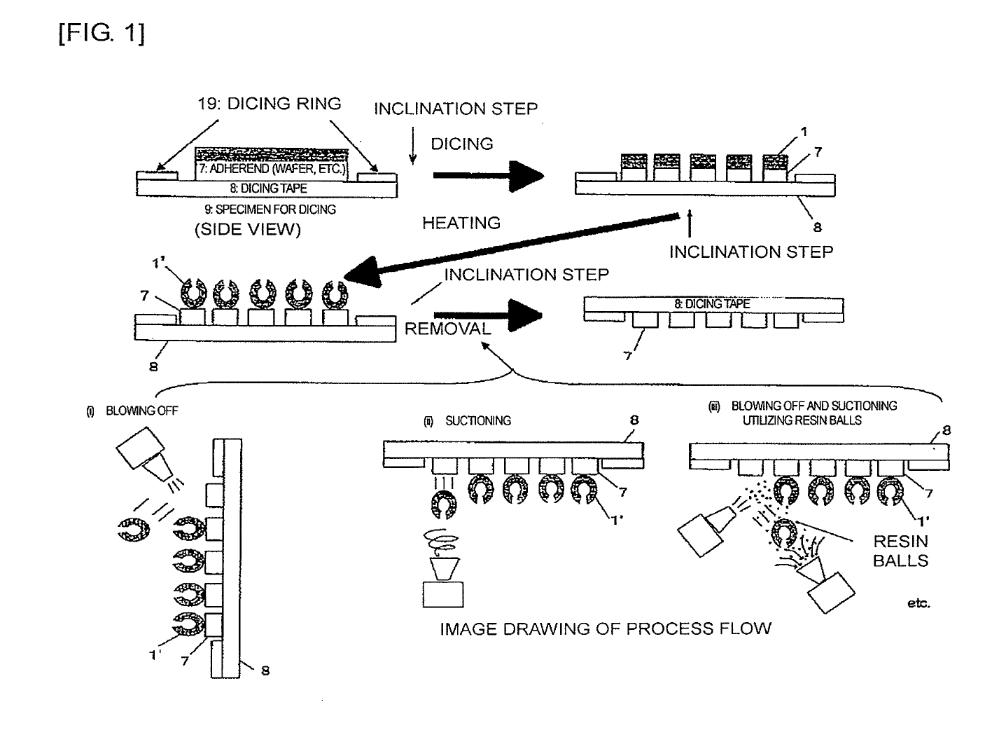

FIG. 1 is a schematic view illustrating one example of a separation method using a dicing surface protection tape (surface protection tape) 1 which separates off while forming a cylindrical roll or rolls. Hereinafter, a description will be given according to FIG. 1.

### <Preparation of Specimens for Dicing>

As illustrated in FIG. 1, the surface protection tape 1 is bonded to an adherend 7, such as a wafer, to form a laminated body. Examples of the adherend 7 include general types of objects which have conventionally been subjected to a dicing process, such as a semiconductor wafer, glass, ceramics, and semiconductor-sealing resin. The way in which the surface protection tape 1 is bonded to the adherend 7, such as a wafer, is not limited in particular. The tape can be bonded using, for example, a hand roller.

As the adherend 7, a semiconductor wafer, such as an 8-inch silicon mirror wafer, is preferably used. If a semiconductor wafer is used as the adherend, processing, such as back-grinding, may be performed on the adherend of the laminated body, to set the adherend to a predetermined thickness. If the adherend is a semiconductor silicon wafer, it is possible to use a silicon wafer having a thickness of several ten μm to several hundred μm. In particular, it is also possible to use an ultrathin silicon wafer having a thickness of 100 μm or less.

Next, the adherend 7 side of the laminated body comprised of the surface protection tape 1 and the adherend 7 is bonded to a dicing tape 8, to form a laminated body comprised of the surface protection tape 1, the adherend 7 and the dicing tape 8. The dicing tape 8 is not limited in particular, but a heretofore-known dicing tape can be used. This laminated body is defined as a specimen for dicing 9. This laminated body may be further bonded to a dicing ring 19. The dicing ring 19 may not be used, however. A method for bonding the laminated body comprised of the surface Protection tape 1, the adherend 7 and the dicing tape 8 to the dicing tape 8 is not limited in particular. For example, the laminated body can be bonded using a hand roller.

### <Dicing>

Subsequently, the specimen for dicing 9 is diced. Dicing can be performed using a heretofore-known dicing apparatus. The specimen can be diced by means of blade dicing, laser dicing, or the like. Dicing may be performed while pouring water. The pouring rate of cutting water is not limited in particular, but can be set to, for example, 1 L/min. By dicing, the specimen 9 is formed into, for example, 5 mm×5 mm or 10 mm×10 mm chips.

In the case of blade dicing, a dicing speed and a blade rotational speed can be set optionally, according to the material and thickness of the adherend 7. If the adherend 7 is a silicon wafer, the dicing speed can be set to, for example, 60 to 100 mm/sec, and preferably 70 to 90 mm/sec. The blade rotational speed can be set to, for example, 30000 to 50000 rpm, and preferably 35000 to 45000 rpm. A blade height can be set optionally, as appropriate, within a heretofore-known range.

The surface protection tape 1 used in the present invention, when bonded to the adherend 7, is cut together with the adherend 7. The surface protection tape 1 is of such a nature as can be reliably bonded to the adherend 7 and can be prevented from flying off at the time of dicing.

Such a laminated body comprised of the surface protection tape 1 and the adherend exhibits excellent dicing properties. Thus, the laminated body neither causes any breakage or cracking in the wafer nor allows water used during dicing to enter a boundary face between the surface protection tape 1 and the adherend 7, thereby making available chips in which the surface protection tape 1 and the adherend 7 are laminated.

### <Application of Shrinkage-inducing Stimulus>

The surface protection tape 1 in the method of the present invention preferably curls up and spontaneously separates off from the adherend 7 by the application of a contraction-inducing stimulus, such as heat. In FIG. 1, heating is performed by way of example as a contraction-inducing stimulus, but the stimulus is not limited to heating. As illustrated in FIG. 1, if the contraction-inducing stimulus, such as heating, is applied to a chip obtained by dicing, the surface protection tape 1 transforms in an arc into a roll 1′. A contact point between the roll 1′ and the adherend 7 is smaller than those of any other optional shapes in which peeling liners of other conventional examples are transformed, and the roll 1′ preferably has a cylindrical shape. Accordingly, the contact point between the roll 1′ and the adherend 7 is formed of, for example, a single line segment alone.

Note that the timing of heating for the purpose of separating the surface protection tape 1 is optional, and is not limited in particular. From the viewpoint of protecting the adherend 7, however, the timing should be as late as possible, and is preferably a critical point in time at which separation is required.

If such a surface protection tape 1 is caused to spontaneously curl up by, for example, heating, such curling is made to unfailingly take place with excellent reproducibility by selecting predetermined conditions, including heating temperature and tape composition. Thus, it is possible to reliably separate the tape from the adherend 7. Accordingly, no failure is involved in separating the surface protection tape.

A contraction-inducing stimulus, such as heating, may be applied uniformly to the entire surface of the surface protection tape, stepwise to the entire surface, or partially to a surface of the tape only for the purpose of creating a trigger for separation, according as needed at the time of performing separation work. For example, the heating temperature and time of a pressure-sensitive adhesive sheet can be adjusted as appropriate, according to the contractility of a heat-shrinkable base material to be used. Thus, the temperature can be specified as a temperature for the surface protection tape to spontaneously separate off. The heating time is, for example, 5 to 600 seconds, preferably 5 to 300 seconds, and more preferably 5 to 180 seconds.

A heating method is not limited in particular, but a heat source, such as a hot plate, a heat gun or an infrared lamp, can be mentioned. In the case of heating by, for example, a hot plate, surface protection tapes on all chips on the hot plate spontaneously curl up at the same time. In the case of heating by, for example, a heat gun, local heating of chips is also possible. Accordingly, it is possible to cause surface protection tapes on only some of the chips to spontaneously roll up as necessary.

The heating temperature of the surface protection tape 1, for example, an upper temperature limit is not limited in particular, as long as the temperature allows the tape to curl up without affecting the object to be cut. For example, the temperature can be set to 50° C. or higher, preferably 50° C. to 180° C., and more preferably 70° C. to 180° C. If the heating temperature is lower than 50° C., it is not possible to obtain a degree of transformation sufficient for the surface protection tape 1 to separate off or transformation does not take place promptly. If the heating temperature is too high, such problems as the breakage of the adherend 7 may occur.

The magnitude of the diameter r of an arc drawn by the roll 1′ formed as the tape 1 spontaneously curls up, can be adjusted as appropriate, according to, for example, heating conditions, such as heating temperature and the amount of hot airstream, and the composition and structure of the surface protection tape 1. That is, the way in which the roll 1′ curls up is preferably determined by the heating conditions, the composition of the surface protection tape 1, and the like. The degree of curling up becomes higher with a decrease in the diameter r. The surface protection tape 1 is transformed by heating into, preferably, a cylindrical roll.

The roll 1′ is formed due to, for example, the heating-induced contraction stress of a shrinkable base material. The development of contraction stress is a heat-irreversible process (the tape, even if reheated, does not restore to a state of being not shrunk). Consequently, once the tape rolls up, the tape does not unroll by itself even if kept heated. In addition, the tape does not easily unroll even by stress, due to the high elasticity of post-heating contractile and rigid base materials, thus retaining a given shape. Accordingly, the roll 1′ does not easily collapse or unroll.

For example, in the case of such a laminated body as illustrated in FIG. 4 or FIG. 8, a stress of, for example, 1.3 N/10 mm or greater is estimated to be required, in order to unwind a roll formed by heating at 80° C. and for 30 seconds or so. In addition, a load of, for example, 250 to 300 gram-weight is required, in order to shrink the diameter of a 10 mm-wide roll 1′ to one-third. When the load is removed, the diameter of the roll reverts to almost the initial state thereof. In addition, as described above, the way in which the roll 1′ curls up can be determined by setting conditions. Under the conditions, individual chips are formed of substantially the same given shape.

Note that the surface protection tape 1 may contain a UV-hardening tackiness agent. In this case, UV irradiation can be performed prior to applying a contraction-inducing stimulus, such as heating, for the self-rolling of the surface protection tape 1. The UV irradiation may be performed simultaneously with the application of the stimulus.

Then, as illustrated in FIG. 1, the object to be cut, to which the surface protection tape is bonded, needs to be inclined at an arbitrary stage, at an optional angle up to an angle for the object to turn over. The optional stage may be any stage, for example, a stage prior to a dicing process, a stage after dicing and before application of a stimulus to the surface protection tape, or a stage in a process of separating and removing the surface protection tape. By inclining the object to be cut at any one of these stages, cut-off portions of the surface protection tape are prevented from adhering to a dicing tape and/or a dicing ring in the separation and removal process. In addition, the inclination step may be performed twice or more times.

FIG. 1 illustrates the way in which cut-off portions of the surface protection tape are removed with the object to be cut, to which the surface protection tape is bonded, inclined at 90° to stand upright and with the object inclined at 180° to turn over.

### <Removal>

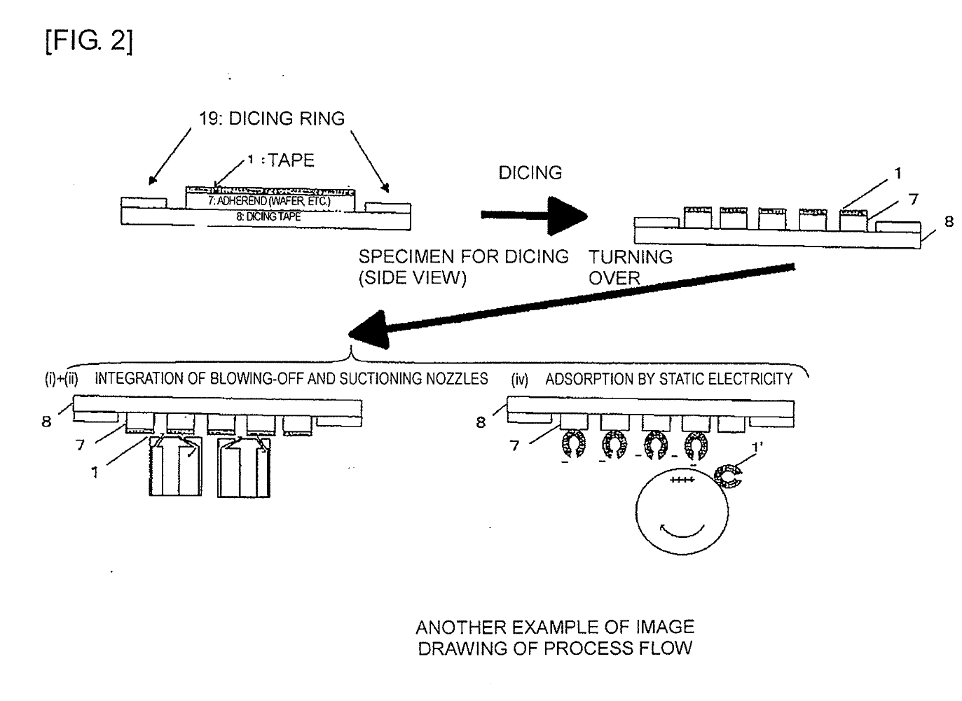

As illustrated in FIGS. 1 and 2, methods for removing the roll 1′ resulting from the transformation of the surface protection tape 1 from the adherend 7 include:

(i) blowing off the roll 1′;

(ii) removing the roll 1′ by means of suction;

(iii) blowing off and suctioning the roll 1′ by utilizing resin balls or the like; and

(iv) separating off the roll 1′ by means of electrostatic attraction.

Removal may be performed after transforming portions of the surface protection tape on all chips into rolls 1′. Alternatively, portions of the surface protection tape on some of the chips which have transformed into rolls 1′ may be removed successively. It is desirable, however, to incline, or more preferably, turn over the object to be cut, to which the surface protection tape is bonded, by the time of a removal step, by going through a step of inclining the object at an arbitrary angle up to an angle for the object to turn over. This is because the surface protection tape does not adhere to a dicing tape and the like.

With the blow-off method in item (i), it is possible to remove the roll 1′ formed on the adherend 7 by blowing off the roll 1′ by using a wind force-generating medium, as illustrated in FIG. 1. The surface protection tape 1 of the present invention is caused to unfailingly transform by applying a contraction-inducing stimulus, such as heating, in a state of the tape 1 having been divided into individual pieces after dicing. Consequently, the tape 1 transforms into rolls 1′ of substantially the same shape. Thus, in every chip, each roll 1′ preferably has contact with the adherend 7 across a single line segment only. Accordingly, the rolls 1′ can be easily removed with a relatively weak force of wind.

As the wind force-generating medium, it is possible to use a widely-known apparatus, such as a blower, a dryer, or an electric fan. Removal by the blow-off method may be performed by, for example, previously heating the surface protection tape 1 to form the roll 1′, and then using, for example, normal-temperature air, warm air or hot air.

In addition, the removal by the blow-off method may be performed, while causing the surface protection tape 1 by, for example, heating to form rolls. In this case, it is possible to use hot air. The temperature of hot air can be determined so that, for example, the surface temperature of the surface protection tape 1 is 80° C. to 100° C.

Air can be blown at the adherend 7 at an angle of, for example, 10° to 50°. The time period of air blow is not limited in particular, but may be set to, for example, 1 to 5 minutes, and preferably 2 to 4 minutes.

In addition, removal of the surface protection tape 1 by the blow-off method in item (i) may be performed while supplementarily heating the adherend 7 and the roll 1′ by using a heating medium, such as a hot plate. In this case, the temperature of supplementary heating using the heating medium can be set to, for example, 50° C. to 70° C.

In the method of removal by suction in item (ii), the roll 1′ formed on the adherend 7 is removed by suctioning the roll 1′ by using a suction medium, as illustrated in FIG. 1. The surface protection tape 1 of the present invention is caused to unfailingly transform by applying a contraction-inducing stimulus, such as heating, in a state of the tape 1 having been divided into individual pieces after dicing. Consequently, the tape 1 transforms into rolls 1′ of substantially the same shape. Thus, in every chip, each roll 1′ preferably has contact with the adherend 7 across a single line segment only. Accordingly, the rolls 1′ can be easily removed with a relatively weak force.

As a suction medium, it is possible to use a widely-known suction apparatus, such as a vacuum cleaner. The suction apparatus may have such a nozzle shape as to produce vortex flows of air at the tip of a suction nozzle. Removal by the method of suction may be performed after forming the roll 1′ by applying a contraction-inducing stimulus, such as heating, to the surface protection tape 1. Alternatively, the removal may be performed while concurrently forming a roll or rolls by, for example, heating the surface protection tape 1.

In addition, removal of the surface protection tape 1 by the method of suction in item (ii) may be performed by preheating the adherend 7 and the roll 1′ by using a heating medium, such as a hot plate. In this case, the temperature of preheating using the heating medium can be set to, for example, 50° C. to 70° C.

FIG. 2 illustrates concomitant use of the blow-off method in item (i) and the suction method in item (ii). From the viewpoint of preventing blown-off rolled-up portions of the surface protection tape from flying off, and reducing the possibility of the rolled-up portions adhering to a dicing sheet and the like, it is more desirable to simultaneously perform suction.

At the time of this concomitant use, it is necessary to position a nozzle for blow-off and a nozzle for suction in the vicinity of the surface protection tape, or arrange a blow-off port for blowing a gas and a suction port adjacently with each other in one nozzle, as illustrated in FIG. 2. In addition, the nozzle for suction or the suction port thereof needs to be made large, so as to cover the range over which a blown-off gas spreads, particularly in order to unfailingly suction blown-off portions of the surface protection tape.

If a gas is blown at rolls 1′ by concurrently using a carrier, such as the resin balls mentioned in item (iii), as illustrated in FIG. 1, while concomitantly using such a method of blow-off as mentioned in item (i) and a method of suction as mentioned in item (ii), the kinetic energy of the carrier is added to the force of wind. Consequently, it is possible to even more reliably remove the surface protection tape. As the resin balls used in this case, sponge-like porous resin balls are preferred, as the balls do not cause damage to the object to be cut. The size of the resin balls may be that of such microscopic particles as to enter a gap between a surface protection tape in a state of being partially separated off from the object to be cut by stimulation and the object to be cut. Alternatively, the size may be similar in diameter to the size of one cut-off piece of the object to be cut. It is also possible to concurrently use vibrations by an ultrasonic transducer, independently of the concomitant use of such a carrier as described above.

As the method using static electricity in item (iv), a rotary electrostatically-charged roller or the like is brought close to a dicing surface protection sheet made removable by stimulation, and is moved along the sheet. Since the charged roller rotates, removed portions of the front surface protection sheet adhere to a surface of the roller closer and opposed to the surface protection sheet, thereby progressing the removal of the surface protection sheet by electrostatic force. This static electricity-based method can collect the surface protection sheet without causing cut-off portions thereof to fly off to a surrounding area. Consequently, it is possible to smoothly proceed with subsequent steps, without causing the cut-off portions of the dicing surface protection sheet to adhere to a dicing sheet and the like.

### [Surface Protection Tape]

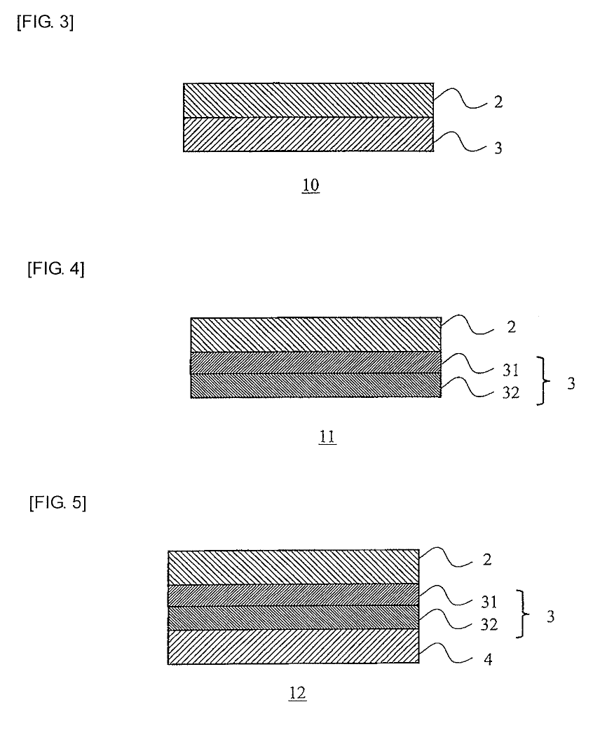

FIG. 3 is a schematic cross-sectional view of a laminated body 10 which is one example of a surface protection tape preferably usable in a method of the present invention. The surface protection tape 1 can be, for example, the laminated body 10 comprised of a shrinkable film layer 2 and a restriction layer 3, as illustrated in FIG. 3. The shrinkable film layer 2 is preferably has uniaxial contractility. The restriction layer 3 functions as a layer for restricting the contraction of the shrinkable film layer 2.

FIG. 4 is a schematic cross-sectional view illustrating a laminated body 11 which is one example of the surface protection tape of the present invention. FIG. 5 is a schematic cross-sectional view illustrating a laminated body 12 which is one example of the surface protection tape of the present invention. The laminated body 11 illustrated in FIG. 4 is a laminated body comprised of the shrinkable film layer 2 having uniaxial contractility and the restriction layer 3 for restricting the contraction of the shrinkable film layer 2.

The shrinkable film layer 2 may be a film layer having contractility at least in a uniaxial direction. Accordingly, the shrinkable film layer 2 may be composed of any one of a heat-shrinkable film, a film which exhibits contractility in response to light, a film which shrinks in response to an electrical stimulus, and the like. Of these films, the shrinkable film layer 2 is preferably composed of a heat-shrinkable film from the viewpoint of work efficiency and the like.

The restriction layer 3 is comprised of an elastic layer 31 on the shrinkable film layer 2 side and a rigid film layer 32 on a side opposite to the shrinkable film layer 2. In addition, the laminated body 12 illustrated in FIG. 5 is such that a tackiness agent layer 4 is laminated on the rigid film layer 32 side of the laminated body 11 illustrated in FIG. 4. In this case, the laminated body 11 of FIG. 4 functions as a supporting base material of the laminated body 12 of FIG. 5.

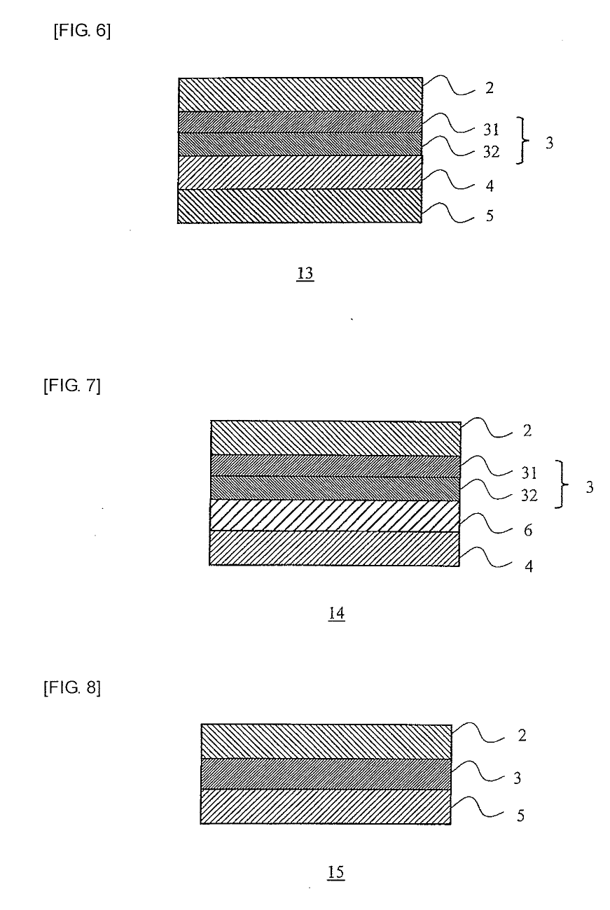

In addition, FIG. 6 is a schematic cross-sectional view of a laminated body 13 which is one example of the surface protection tape of the present invention. The laminated body 13 is such that a peeling liner 5 is laminated on a side opposite to the rigid film layer of the tackiness agent layer 4 of the laminated body 12 illustrated in FIG. 5.

FIG. 7 is a schematic cross-sectional view illustrating a laminated body 14 which is one example of the surface protection tape of the present invention. The laminated body 14 is a laminated body in which a shrinkable film layer 2, an elastic layer 31 serving as a restriction layer 3, and a rigid film layer 32, an intermediate layer 6, and a tackiness agent layer 4 are laminated in this order. By applying a contraction-inducing stimulus, such as heating, the laminated body 14 can be caused to spontaneously curl up in one direction from one end thereof or toward the center thereof from two opposed ends, thereby forming one or two cylindrical rolls. The laminated body 14 is formed by sequentially laminating the shrinkable film layer 2, the elastic layer 31 serving as the restriction layer 3 for restricting the contraction of the shrinkable film layer 2, the rigid film layer 32, the intermediate layer 6, and the tackiness agent layer 4, as illustrated in FIG. 7.

The intermediate layer 6 is positioned between the abovementioned rigid film layer 32 and tackiness agent layer 4. In addition, the intermediate layer 6 serves to alleviate the tensile stress of a composite base material comprised of a shrinkable film layer, an elastic layer and a rigid film layer, thereby suppressing the warpage of a wafer arising when the wafer is ground to an extremely small thickness. The intermediate layer 6 is characterized by exhibiting elasticity lower than that of the rigid film layer.

FIG. 8 is a schematic cross-sectional view illustrating a laminated body 15 which is one example of the surface protection tape of the present invention. The laminated body 15 illustrated in FIG. 8 has a structure in which a shrinkable film layer 2 and an activated energy line-hardening tackiness agent layer 33 are laminated, and a peeling liner 5 is bonded to a surface opposite to the shrinkable film layer 2 of the activated energy line-hardening tackiness agent layer 33.

The laminated body 15 preferably has a structure in which a shrinkable film layer having contractility at least in a uniaxial direction and an activated energy line-hardening tackiness agent layer which, when irradiated with activated energy lines, hardens so that a product of tensile elasticity and thickness at 80° C. is 5×10³ N/m or larger but smaller than 1×10⁵ N/m are laminated and, when heated, can spontaneously curl up in one direction from one end of the laminated body or toward the center thereof from the opposed two ends, thereby forming one or two cylindrical rolls. In addition, the laminated body 15 may have another layer between the abovementioned shrinkable film layer and activated energy line-hardening tackiness agent layer, to the extent of not impairing the self-rolling properties of the laminated body. Preferably, however, the laminated body 15 does not have any layer whose product of tensile elasticity and thickness at 80° C. is 4×10⁵ N/m or larger (1×10⁵ N/m or larger, in particular).

### [Shrinkable Film Layer]

The shrinkable film layer 2 may be a film layer which, when heated, has contractility at least in a uniaxial direction. The shrinkable film layer may have contractility only in a uniaxial direction. Alternatively, the shrinkable film layer may have primary contractility in a certain direction (uniaxial direction), and secondary contractility in a direction different from the abovementioned direction (for example, a direction orthogonal to the abovementioned direction). The shrinkable film layer 1 may be a single layer or a multilayer composed of two or more layers.

The contraction percentage in the direction of primary contraction of the shrinkable film layer 2 is, for example 5 to 90%, preferably 30 to 90%, and particularly preferably 50 to 90% at a predetermined temperature within the range of 70 to 180° C. (for example, at 80° C.). The contraction percentage of a film layer composing the shrinkable film layer in directions other than the direction of primary contraction is preferably 10% or lower, more preferably 5% or lower, and particularly preferably 3% or lower. The thermal contractility of the shrinkable film layer can be imparted by, for example, performing a stretching treatment on a film extruded by an extruder.

Note that in the present specification, the contraction percentage (%) means a value calculated by the expression [(dimensions before contraction−dimensions after contraction)/(dimensions before contraction)]×100 and, unless otherwise noted, refers to a contraction percentage in an axial direction of primary contraction.

Examples of the shrinkable film layer 2 include a uniaxially-stretched film made of one or more than one type of resin selected from the group consisting of, for example, polyester, such as polyethylene terephthalate, polyolefin, such as polyethylene and polypropylene, polynorbornene, polyimide, polyamide, polyurethane, polystyrene, polyvinylidene chloride, and polyvinyl chloride. Of these films, a uniaxially-stretched film made of polyester-based resin, polyolefin-based resin, such as polyethylene, polypropylene, or polynorbornene (including cyclic polyolefin-based resin), or polyurethane-based resin is preferred from the viewpoint of being superior in, for example, the workability of tackiness agent coating. As such a shrinkable film layer, it is possible to utilize a commercially-available product, such as “SPACECLEAN” made by Toyobo, “FANCYWRAP” made by Gunze, “TORAYFAN” made by Toray, “LUMIRROR” made by Toray, “ARTON” made by JSR, “ZEONOR” made by Zeon, “SUNTEC” made by Asahi Kasei, or the like.

Note that if activated energy lines are irradiated through the shrinkable film layer 2 in the laminated body 15 when hardening the activated energy line-hardening tackiness agent layer 33, the shrinkable film layer 2 needs to be made of a material capable of transmitting at least a predetermined amount of activated energy lines (for example, transparent resin).

The thickness of the shrinkable film layer 2 is generally 5 to 300 μm and preferably 10 to 100 μm. If the shrinkable film layer 2 is too thick, the rigidity thereof increases, and therefore, self-rolling does not take place. Accordingly, the laminated body 15 breaks apart at a boundary between the shrinkable film layer 2 and the activated energy line-hardening tackiness agent layer 33 after the irradiation of activated energy lines, thus tending to lead to laminated body breakdown. In addition, a highly rigid film tends to contain stress remaining therein at the time of tape bonding, have a large force of elastic deformation, become warped to a higher degree when a wafer is thinned, and cause an adherend to be liable to breakage due to transportation or the like.

In order to enhance adhesion, retainability and the like with respect to an adjacent layer, conventionally-used surface treatment, for example, chemical or physical treatment, such as chromic acid treatment, ozone exposure, flame exposure, high-voltage electrical shock exposure, ionization radiation treatment, or coating treatment using a base coating material (for example, a sticky substance), may be performed on a surface of the shrinkable film layer 2.

### [Restriction Layer]

The restriction layer 3 serves as a driving force for generating a force couple in a laminated body as a whole and causing rolling up by restricting the contraction of the shrinkable film layer 2 and producing a counteracting force. In addition, secondary contraction in directions different from the direction of primary contraction of the shrinkable film layer 2 is suppressed by this restriction layer 3. Thus, the restriction layer 3 is considered to also serve to allow the contraction directions of the shrinkable film layer 2, whose contractility, though considered uniaxial, cannot be necessarily said to be uniform, to converge on one direction. Accordingly, if heat for facilitating the contraction of the shrinkable film layer 2 is applied to a laminated sheet, a repulsive force against the contraction force of the shrinkable film layer 2 in the restriction layer 3 serves as a driving force, thus causing an outer edge or edges of the laminated sheet (one end or two opposed ends) to lift. It is therefore considered that the laminated sheet spontaneously curls up in one direction or toward the center thereof from an end or ends thereof (normally, in the axial direction of primary contraction of the shrinkable film layer) with the shrinkable film layer 2 side facing inward, thereby forming a cylindrical roll or rolls. In addition, with this restriction layer 3, it is possible to prevent a shear force produced by the contractive transformation of the shrinkable film layer 2 from being transmitted to the tackiness agent layer 4 and/or the adherend. Consequently, it is possible to prevent the breakage of a tackiness agent layer (for example, a hardened tackiness agent layer) decreased in tackiness at the time of re-separation, the breakage of the adherend, and the contamination of the adherend due to the broken tackiness agent layer.

The restriction layer 3 exhibits the capability of restricting the contraction of the shrinkable film layer 2, and therefore, has adhesiveness (including tackiness) with respect to the elastic and shrinkable film layer 2. In addition, the restriction layer 3 preferably has a certain degree of toughness or rigidity, in order to allow cylindrical rolls to be formed smoothly. The restriction layer 3 may be composed of either a single layer of multiple layers to which functions are separately allocated. The restriction layer 3 is preferably composed of an elastic layer 31 and a rigid film layer 32.

### [Elastic Layer]

The elastic layer 31 is preferably easy to transform, i.e., is in a rubbery state, under the temperature (or under the temperature when the laminated body 12 and the laminated body 13 are separated, if the laminated body 11 is used as a supporting base material of a surface protection tape in the laminated body 12 and the laminated body 13 serving as the surface protection tape 1) at which the shrinkable film layer 2 contracts. However, a material having fluidity does not generate an adequate counteracting force, and eventually, the shrinkable film layer contracts by itself, thus failing to cause transformation (self-rolling). Therefore, the elastic layer 31 is preferably of such a type that fluidity is suppressed by three-dimensional cross-linkage or the like. In addition, the elastic layer 31 has the function of preventing contractive transformation by the weak force components of the non-uniform contraction forces of the shrinkable film layer 2, with resistance to the weak force components, also due to the thickness of the elastic layer 31, thereby converting the direction of contraction to a direction of uniform contraction. Warpage arising after the grinding of a wafer is considered to occur because stress caused when the pressure-sensitive adhesive sheet is bonded to the wafer remains, and the shrinkable film layer is elastically transformed by this residual stress. The elastic layer also has the function of alleviating this residual stress to lower the degree of warpage.

Accordingly, the elastic layer 31 is desirably formed using a resin having tackiness and having a glass-transition temperature of, for example, 50° C. or lower, preferably room temperature (25° C.) or lower, and more preferably 0° C. or lower. The tack strength of the shrinkable film layer 2 side surface of the elastic layer 31, when measured under the values to a 180° peel test (compliant to JIS Z 0237, tensile rate: 300, mm/min, temperature: 50° C.), is preferably 0.5 N/10 mm or higher. If this tack strength is too low, separation is liable to take place between the shrinkable film layer 2 and the elastic layer 31.

In addition, the shear elastic modulus G of the elastic layer 31 is preferably 1×10⁴ Pa to 5×10⁶ Pa (particularly preferably 0.05×10⁶ Pa to 3×10⁶ Pa) over the range from room temperature (25° C.) to temperature at the time of separation (for example, 80° C.) If the shear elastic modulus is too small, the elastic layer 31 lacks in the function of converting the contraction stress of the shrinkable film layer to stress necessary for the laminated body to curl up. Conversely, if the shear elastic modulus is too large, the elastic layer 31 lacks in roll-up properties as the layer becomes stiffer. This is because a highly elastic layer is generally inferior in tackiness and tends to make it difficult to fabricate a laminated body. In addition, the elastic layer lacks in the function of alleviating residual stress. The thickness of the elastic layer 31 is preferably 15 to 150 μm or so. If the thickness is too small, restriction on the contraction of the shrinkable film layer 2 becomes difficult to obtain and the effect of stress relaxation reduces. Conversely, if the thickness is too large, the self-rolling properties degrade. In addition, the elastic layer 31 becomes inferior in handleability and economic efficiency and is therefore not preferable. Accordingly, a product of the shear elastic modulus G (for example, a value at 80° C.) and the thickness of the elastic layer 31 (shear elastic modulus G×thickness) is preferably 1 to 1000 N/m (more preferably 1 to 150 N/m, and even more preferably 1.2 to 100 N/m).

If the tackiness agent layer 4 is an activated energy line-hardening tackiness agent layer, the elastic layer 31 is preferably formed of a material easy to transmit activated energy lines. In addition, from the viewpoint of manufacture, workability and the like, the elastic layer 31 is preferably of such a type that the thickness thereof can be selected as appropriate, so that the elastic layer 31 is easy to form into a film-like shape and is therefore superior in forming processability.

As the elastic layer 31, it is possible to use, for example, a foamed material (foamed film), such as urethane foam or acrylic foam, rubber, or a resin film (including sheets), such as a non-foamed resin film, made of thermoplastic elastomer or the like, on a surface (at least the shrinkable film layer 2-side surface) of which tackiness treatment has been performed. A tackiness agent used for tackiness treatment is not limited in particular. It is therefore possible to use one or more than one type of heretofore-known tackiness agent in combination, selected from the group consisting of, for example, an acrylic-based tackiness agent, a rubber-based tackiness agent, a vinyl alkyl ether-based tackiness agent, a silicone-based tackiness agent, a polyester-based tackiness agent, a polyamide-based tackiness agent, an urethane-based tackiness agent, and a styrene-diene block copolymer-based tackiness agent. In particular, the acrylic-based tackiness agent is preferably used from the viewpoint of tack strength adjustability and the like. Note that the resin of a tackiness agent used for tackiness treatment and the resin of a foamed film or a non-foamed resin film are preferably of the same type, in order to obtain high affinity. If, for example, the acrylic-based tackiness agent is used for tackiness treatment, acrylic foam or the like is preferred as a foamed material.

In addition, the elastic layer 31 may be formed of a resin composition, such as a cross-linked ester-based tackiness agent or a cross-linked acrylic-based tackiness agent, having adhesiveness in itself. A layer (tackiness agent layer) formed of such a cross-linked ester-based tackiness agent or a cross-linked acrylic-based tackiness agent as described above does not require separately performing tackiness treatment. Thus, the layer can be manufactured in a comparatively simple and convenient way, is superior in productivity and economic efficiency, and is therefore preferably used.

The abovementioned cross-linked ester-based tackiness agent has a composition in which a cross-linking agent has been added to an ester-based tackiness agent with an ester-based polymer as the base polymer thereof. Examples of the ester-based polymer include a polyester made of a condensation polymer composed of diol and dicarboxylic acid.

Examples of the diol include (poly)carbonate diol. Examples of the (poly)carbonate diol include (poly)hexamethylene carbonate diol, (poly)-3-methyl (pentamethylene) carbonate diol, (poly)trimethylene carbonate diol, and copolymers thereof. The diol component or (poly) carbonate diol can be used independently, or two or more types thereof can be used in combination. Note that if the (poly) carbonate diol is polycarbonate diol, the degree of polymerization thereof is not limited in particular.

Examples of commercially-available products of the (poly) carbonate diol include “PLACCEL CD208PL,” “PLACCEL CD210PL,” “PLACCEL CD220PL,” “PLACCEL CD208,” “PLACCEL CD210,” “PLACCEL CD220,” “PLACCEL CD208HL,” “PLACCEL CD210HL” and “PLACCEL CD220HL,” which are products made by Daicel Chemical Industries, Ltd. and are the trade names thereof.

As the diol component, a component, such as ethylene glycol, propylene glycol, butane diol, hexane diol, octane diol, decane diol, or octadecane diol, may be concomitantly used as necessary, in addition to the (poly)carbonate diol.

In addition, as the dicarboxylic acid, it is possible to preferably use a dicarboxylic acid component with an aliphatic or alicyclic hydrocarbon radical having a carbon number of 2 to 20 as the molecular frame thereof, or a dicarboxylic acid component containing a reactive derivative of the dicarboxylic acid as the essential constituent thereof. In the abovementioned dicarboxylic acid with an aliphatic or alicyclic hydrocarbon radical having a carbon number of 2 to 20 as the molecular frame thereof, or the reactive derivative thereof, the hydrocarbon radical may be either in a straight-chain state or in a branched-chain state. Typical examples of such dicarboxylic acid or the reactive derivative thereof include succinic acid, methyl succinic acid, adipic acid, pimelic acid, azelaic acid, sebacic acid, 1,12-dodecanedioic acid, 1,14-tetradecanedioic acid, tetrahydrophthalic acid, endo methylenetetrahydrophthalic acid, and the acid anhydrides and the lower alkyl ester thereof. The dicarboxylic acid component can be used independently, or two or more types thereof can be used in combination.

As a combination of the diol and the dicarboxylic acid, it is possible to preferably use polycarbonate diol in combination with sebacic acid, adipic acid, pimelic acid, suberic acid, azelaic acid, phthalic acid, maleic acid, or the like.

The abovementioned cross-linked acrylic-based tackiness agent has a composition in which a cross-linking agent has been added to an acrylic-based tackiness agent with an acrylic-based polymer as the base polymer thereof. Examples of the acrylic-based polymer include a monomer or a copolymer of alkyl ester of (meth)acrylate, such as C₁-C₂₀ alkyl ester of (meth)acrylate, including methyl(meth)acrylate, ethyl (meth)acrylate, butyl(meth)acrylate, 2-ethylhexyl (meth)acrylate, and octyl(meth)acrylate; and a copolymer composed of the alkyl ester of (meth)acrylate and other copolymerizable monomers [for example, a carboxyl group or an acid anhydride group-containing monomer, such as acrylic acid, methacrylic acid, itaconic acid, fumaric acid, or maleic acid anhydride; a hydroxyl group-containing monomer, such as 2-hydroxyethyl (meth)acrylate; an amino group-containing monomer, such as morpholyl(meth)acrylate; an amide group-containing monomer, such as amide(meth)acrylate; a cyano group-containing monomer, such as (meth)acrylonitrile; and (meth)acrylic acid ester having an alicyclic hydrocarbon radical, such as isobornyl(meth)acrylate].

As the acrylic-based polymer, a copolymer composed of one or more than one type of C₁-C₁₂ alkyl ester of (meth)acrylate, such as ethyl acrylate, butyl acrylate, and 2-ethylhexyl acrylate and at least one type of copolymerizable monomer selected from the group consisting of a hydroxyl group-containing monomer, such as 2-hydroxyethyl acrylate, and a carboxyl group- or acid anhydride group-containing monomer, such as acrylic acid, or a copolymer composed of one or more than one type of C₁-C₁₂ alkyl ester of (meth)acrylate, (meth)acrylic acid ester having an alicyclic hydrocarbon radical, and at least one type of copolymerizable monomer selected from the group consisting of a hydroxyl group-containing monomer and a carboxyl group- or acid anhydride group-containing monomer is particularly preferred.

The acrylic-based polymer is prepared as a high-viscosity liquid prepolymer by, for example, solventlessly photopolymerizing (polymerizing using ultraviolet rays or the like) the monomer component (and a polymerization initiator) cited as examples above. Next, by adding a cross-linking agent to this prepolymer, it is possible to obtain a cross-linked acrylic-based tackiness agent composite. Note that the cross-linking agent may be previously added at the time of manufacturing the prepolymer. By adding a cross-linking agent and a solvent (not necessarily be needed if a solution of acrylic-based polymer is used) to an acrylic-based polymer or a solution thereof obtained by polymerizing the monomer component cited as examples above, it is also possible to obtain a cross-linked acrylic-based tackiness agent composite.

The cross-linking agent is not limited in particular. Accordingly, it is possible to use, for example, an isocyanate-based cross-linking agent, a melamine-based cross-linking agent, an epoxy-based cross-linking agent, an acrylate-based cross-linking agent (polyfunctional acrylate), and (meth)acrylic acid ester having an isocyanate group. As the acrylate-based cross-linking agent, hexanediol diacrylate, 1,4-butanediol diacrylate, trimethylolpropane triacrylate, pentaerythritol tetraacrylate, dipentaerythritol hexaacrylate, and the like are cited as examples. As the (meth)acrylic acid ester having an isocyanate group, 2-isocyanatoethyl acrylate, 2-isocyanatoethyl methacrylate, and the like are cited as examples. Of these materials, an ultraviolet (UV)-responsive cross-linking agent, such as the acrylate-based cross-linking agent (polyfunctional acrylate) and the (meth)acrylic acid ester having an isocyanate group, is preferred as the cross-linking agent. The additive amount of cross-linking agent is normally 0.01 to 150 pts. wt. or so, preferably 0.05 to 50 pts. wt. or so, and particularly preferably 0.05 to 30 pts. wt. or so, for a 100 pts. wt. of the abovementioned base polymer.

The cross-linked acrylic-based tackiness agent may contain appropriate additives, such as a cross-linking accelerator, a tackifier (for example, rosin derivative resin, polyterpene resin, petroleum resin, or oil-soluble phenol resin), a viscosity improver, a plasticizer, a filler, an anti-aging agent, and an anti-oxidizing agent, in addition to the base polymer and the cross-linking agent.

A cross-linked acrylic-based tackiness agent layer serving as the elastic layer 31 can be obtained by, for example, forming a cross-linked acrylic-based tackiness agent composite obtained by adding a cross-linking agent to the abovementioned prepolymer into a film-like shape having a desired thickness and area by using a heretofore-known method, such as a cast method, and once again light-irradiating the tackiness agent composite to facilitate cross-linking reaction (and polymerizing unreacted monomers). Thus, it is possible to simply and conveniently obtain the elastic layer 31 for serving the purpose thereof. The elastic layer (cross-linked acrylic-based tackiness agent layer) thus obtained has self-adhesiveness, and therefore, can be used by directly bonding the layer between the shrinkable film layer 2 and the rigid film layer 32. As the cross-linked acrylic-based tackiness agent layer, it is possible to utilize a commercially-available double-sided adhesive tape, such as “HJ-9150W” (trade name) made by Nitto Denko Corporation. Note that the film-like tackiness agent may previously be bonded between the shrinkable film layer 2 and the rigid film layer 32, and then the tackiness agent may be once again light-irradiated to cause cross-linking reaction.

In addition, the cross-linked acrylic-based tackiness agent layer serving as the elastic layer 31 can also be obtained by coating a cross-linked acrylic-based tackiness agent composite, which is prepared by dissolving the abovementioned acrylic-based polymer and cross-linking agent in a solvent, on a surface of the rigid film layer 32, bonding the shrinkable film layer 2 onto the tackiness agent composite, and then applying light irradiation. Note that if the tackiness agent layer 4 is an activated energy line-hardening tackiness agent layer, the abovementioned cross-linked acrylic-based tackiness agent may be hardened (cross-linked) at the time of re-separation by activated energy line irradiation (light irradiation) used at the time of hardening the tackiness agent layer 4.

Beads, such as glass beads or resin beads, may further be added to the constituent components of the elastic layer 31 in the present invention. Adding glass beads or resin beads to the elastic layer 31 is advantageous in that the tackiness characteristics and the shear elastic modulus of the elastic layer 31 are easy to control. The average grain diameter of beads is, for example, 1 to 100 μm, and preferably 1 to 20 μm or so. The additive amount of beads is, for example, 0.1 to 10 pts. wt., and preferably 1 to 4 pts. wt, for a total 100 pts. wt. of the elastic layer 31. If the additive amount is too large, the tackiness characteristics may degrade and, if the additive amount is too small, the abovementioned advantageous effect tends to fall short.

### [Rigid Film Layer]

The rigid film layer 32 has the function of producing a counteracting force against the contraction force of the shrinkable film layer 2 by imparting rigidity or toughness to the restriction layer 3, and consequently generating a force couple necessary for roll-up. By providing the rigid film layer 32, a laminated sheet or a pressure-sensitive adhesive sheet is allowed to smoothly roll up spontaneously, without stopping halfway or curling up in a wrong direction, thereby forming a well-shaped cylindrical roll or rolls, when a contraction-inducing stimulus, such as heating, is applied to the shrinkable film layer 2.

Examples of a rigid film composing the rigid film layer 32 include a film made of one or more than one type of resin selected from the group consisting of, for example, polyester, such as polyethylene terephthalate, polybutylene terephthalate, and polyethylene naphthalene; polyolefin, such as polyethylene and polypropylene; polyimide; polyamide; polyurethane; styrene-based resin, such as polystyrene; polyvinylidene chloride; and polyvinyl chloride. Of these films, the polyester-based resin film, the polypropylene film, the polyamide film, and the like are preferred from the viewpoint of being superior in the workability of tackiness agent coating. The rigid film layer 32 may be formed of either a single layer or multiple layers in which two or more layers are laminated. The rigid film composing the rigid film layer 32 is noncontractile, and the contraction percentage of the rigid film is, for example, 5% or lower, preferably 3% or lower, and more preferably 1% or lower.

The product of the Young's modulus and the thickness of the rigid film layer 32 (Young's modulus×thickness) under the temperature at the time of separation (for example, 80° C.) is preferably 3.0×10⁵ N/m or smaller (for example, 1.0×10² to 3.0×10⁵ N/m), and more preferably 2.8×10⁵ N/m or smaller (for example, 1.0×10³ to 2.8×10⁵ N/m). If the product of the Young's modulus and the thickness of the rigid film layer 32 is too small, the rigid film layer 32 lacks in the effect of converting the contraction stress of the shrinkable film layer 2 to roll-up stress, and tends to also degrade the direction-converging effect of the rigid film layer 32. Conversely, if the product is too large, the sheet is liable to be restrained by rigidity from curling up. The Young's modulus of the rigid film layer 32 under the temperature at the time of separation (for example, 80° C.) is preferably 3×10⁶ to 2×10¹⁰ N/m², and more preferably 1×10⁸ to 1×10¹⁰ N/m². If the Young's modulus is too small, it becomes difficult to obtain a well-shaped curled-up cylindrical roll or rolls. Conversely, if the Young's modulus is too small, self-rolling is less likely to take place. The thickness of the rigid film layer 32 is, for example, 20 to 150 μm, preferably 25 to 95 μm, more preferably 30 to 90 μm, and particularly preferably 30 to 80 μm or so. If the thickness is too small, it is difficult to obtain a well-shaped curled-up cylindrical roll or rolls. If the thickness is too large, the self-rolling properties of the rigid film layer 32 degrade. In addition, the rigid film layer 32 becomes inferior in handleability and economic efficiency and is therefore not preferable.

If the tackiness agent layer 4 is an activated energy line-hardening tackiness agent layer, the rigid film layer 32 is preferably formed of a material easy to transmit activated energy lines. In addition, from the viewpoint of manufacture, workability and the like, the rigid film layer 32 is preferably of such a type that the thickness thereof can be selected as appropriate, so that the rigid film layer 32 is easy to form into a film-like shape and is therefore superior in forming processability.

Although in the above-described example, the restriction layer 3 is composed of the elastic layer 31 and the rigid film layer 32, the restriction layer 3 need no necessarily be composed as described above. For example, it is possible to omit the rigid film layer 32 by imparting moderate rigidity to the elastic layer 31.

### [Tackiness Agent Layer]

As the tackiness agent layer 4, it is possible to use a tackiness agent layer inherently low in tack strength. However, the tackiness agent layer 4 preferably has tackiness with which the layer can be bonded to an adherend. In addition, the tackiness agent layer 4 is preferably a removable tackiness agent layer whose tackiness can be reduced or eliminated in some way (detackification treatment) after the completion of the predetermined role of the layer. Such a removable tackiness agent layer as described above can be composed in the same way as the tackiness agent layer of a heretofore-known removable pressure-sensitive adhesive sheet. From the viewpoint of self-rolling properties, the tack strength (180° peel-off applied to a silicon mirror wafer at a tensile rate of 300 mm/min) of a tackiness agent layer or a post-detackification treatment tackiness agent layer is desirably, for example, 6.5 N/10 mm or lower (particularly 6.0 N/10 mm or less) at normal temperature (25° C.)

As the tackiness agent layer 4, it is possible to preferably use an activated energy line-hardening tackiness agent layer. The activated energy line-hardening tackiness agent layer can be composed of such a material that has tacky adhesiveness in its initial state and forms a three-dimensional mesh structure and thereby becomes highly elastic upon irradiation with activated energy lines, such as infrared rays, visible light rays, ultraviolet rays, X-rays, electron beams, or the like. As such a material, it is possible to utilize, for example, an activated energy line-hardening tackiness agent. The activated energy line-hardening tackiness agent contains a compound chemically modified by an activated energy line-reactive functional group for imparting an activated energy line-hardening property, or an activated energy line-hardening compound (or an activated energy line-hardening resin). Accordingly, as the activated energy line-hardening tackiness agent, a tackiness agent composed of a base material chemically modified by an activated energy line-reactive functional group, or composed of a composite in which an activated energy line-hardening compound (or an activated energy line-hardening resin) is blended with the base material, is preferably used.

As the abovementioned base material, it is possible to use a sticky substance, such as a heretofore-known pressure-sensitive adhesive agent (tackiness agent). For the tackiness agent, a rubber-based tackiness agent using a rubber-based polymer, such as natural rubber, polyisobutylene rubber, styrene-butadiene rubber, styrene-isoprene-styrene block copolymer rubber, reclaimed rubber, butyl rubber, polyisobutylene rubber or NBR, as the base polymer thereof; a silicone-based tackiness agent; an acrylic-based tackiness agent are cited as examples. Of these tackiness agents, the acrylic-based tackiness agent is preferred. The base material may be composed of one or more than one type of component.

For the acrylic-based tackiness agent, there is cited, as an example, an acrylic-based tackiness agent using, as the base polymer thereof, an acrylic-based polymer, such as a monomer or a copolymer of alkyl ester of (meth)acrylate, such as C₁-C₂₀ alkyl ester of (meth)acrylate, including methyl(meth)acrylate, ethyl (meth)acrylate, butyl(meth)acrylate, 2-ethylhexyl (meth)acrylate, and octyl(meth)acrylate; and a copolymer composed of the alkyl ester of (meth)acrylate and other copolymerizable monomers [for example, a carboxyl group or an acid anhydride group-containing monomer, such as acrylic acid, methacrylic acid, itaconic acid, fumaric acid, or maleic acid anhydride; a hydroxyl group-containing monomer, such as 2-hydroxyethyl (meth)acrylate; an amino group-containing monomer, such as morpholyl(meth)acrylate; and an amide group-containing monomer, such as amide(meth)acrylate]. One type of these tackiness agents can be used independently or two or more types can be used in combination.

The activated energy line-reactive functional group and the activated energy line-hardening compound used for chemical modification to harden the activated energy line-hardening tackiness agent by activated energy lines are not limited in particular, as long as the group and compound can be hardened by activated energy lines, such as infrared rays, visible light rays, ultraviolet rays, X-rays or electron beams. However, the group and compound are preferably of such a type that the activated energy line-hardening tackiness agent after activated energy line irradiation is efficiently reticulated three-dimensionally (turned into a mesh structure). One type of these groups and compounds can be used independently or two or more types can be used in combination. Examples of the activated energy line-reactive functional group used for chemical modification include a functional group having a carbon-carbon multiple bond, such as an acryloyl group, a methacryloyl group, a vinyl group, an allyl group, and an acetylenic group. These functional groups generate radicals as the carbon-carbon multiple bond is cleaved by activated energy line irradiation. These radicals serve as cross-linking points to enable the functional groups to form a three-dimensional mesh structure. Of these groups, the (meth)acryloyl group is preferred from the viewpoint of reactiveness and workability, as the group can exhibit comparatively high reactivity with respect to activated energy lines and can be used in combination by selection from a wide variety of acrylic-based tackiness agents.

Typical examples of the base material chemically modified by an activated energy line-reactive functional group include a polymer obtained by reacting a compound [for example, (meth)acryloyl oxyethylene isocyanate] having within the molecule thereof a group (an isocyanate group, an epoxy group, or the like) and an activated energy line-reactive functional group (an acryloyl group, a methacryloyl group, or the like) reactive with the abovementioned reactive functional group, with a reactive functional group-containing acrylic-based polymer in which a monomer containing a reactive functional group, such as a hydroxyl group or a carboxyl group [for example, 2-hydroxyethyl(meth)acrylate or (meth)acrylate] is copolymerized with (meth)acrylate alkyl ester.

The ratio of the monomer containing the reactive functional group in the abovementioned reactive functional group-containing acrylic-based polymer is, for example, 5 to 40 wt %, and preferably 10 to 30 wt %, for all monomers. The amount of compound having within the molecular thereof the group and the activated energy line-reactive functional group reactive with the reactive functional group used when reacted with the abovementioned reactive functional group-containing acrylic-based polymer is, for example, 50 to 100 mole %, and preferably 60 to 95 mole %, with respect to the reactive functional group (a hydroxyl group, a carboxyl group, or the like) in the reactive functional group-containing acrylic-based polymer.

Examples of the activated energy line-hardening compound include a compound having two or more carbon-carbon double bonds, including a compound containing a poly(meth)acryloyl group, such as trimethylolpropane tetraacrylate, tetramethylolmethane tetraacrylate, pentaerythritol triacrylate, pentaerythritol tetraacrylate, dipentaerythritol monohydroxy pentaacrylate, dipentaerythritol hexaacrylate, 1,4-butane diol diacrylate, 1,6-hexane diol diacrylate, and polyethylene glycol diacrylate. These compounds may be used independently or two or more types of the compounds may be used in combination. Of these compounds, the poly(meth)acryloyl group-containing compound is preferred, and is cited as an example in, for example, Japanese Patent Laid-Open No. 2003-292916. Hereinafter, the poly(meth)acryloyl group-containing compound may be referred to as an “acrylate-based cross-linking agent.”

As the activated energy line-hardening compound, it is also possible to use, for example, a mixture of organic salt, such as onium salt, and a compound having within the molecular thereof a plurality of heterocyclic rings. The abovementioned mixture can form a three-dimensional mesh structure as the result that organic salt is cleaved by activated energy line irradiation to generate ions, and these ions serve as initiation seeds to trigger the ring-opening reaction of heterocyclic rings. The organic salts include iodonium salt, phosphonium salt, antimonium salt, sulfonium salt, and borate salt. The heterocyclic rings in the compound having within the molecule thereof a plurality of heterocyclic rings include oxirane, oxetane, oxolane, thiirane, and aziridine. Specifically, it is possible to use compounds and the like described in Light Cure Technologies (2000) compiled by Technical Information Institute Co., Ltd.

Examples of the activated energy line-hardening resin include a photosensitive reactive group-containing polymer or oligomer, such as ester (meth)acrylate, urethane (meth)acrylate, epoxy(meth)acrylate, melamine (meth)acrylate, and acrylic resin (meth)acrylate having a (meth)acryloyl group at the molecular end thereof, cationic photopolymerization-type resin having an allyl group at the molecular end thereof, a cinnamoyl group-containing polymer, such as thiol-ene added resin and polyvinyl cinnamate, diazotized amino novolac resin, and an acrylamide type polymer. Examples of polymers reactive to higher-activated energy lines include epoxidized polybutadiene, unsaturated polyester, polyglycidyl methacrylate, polyacrylamide, and polyvinyl siloxane. Note that if an activated energy line-hardening resin is used, the abovementioned base material is not necessarily be needed.

The activated energy line-hardening tackiness agent is particularly preferably composed of a combination of an acrylic-based polymer chemically modified by the abovementioned acrylic-based polymer or activated energy line-reactive functional group (an acrylic-based polymer to the side chain of which an activated energy line-reactive functional group has been introduced) and the abovementioned activated energy line-hardening compound (for example, a compound having two or more carbon-carbon double bonds). The abovementioned combination is preferable from the viewpoint of reactiveness and workability, since the combination contains an acrylate group exhibiting comparatively high reactivity to activated energy lines, and can be selected from a variety of acrylic-based tackiness agents. Specific examples of such a combination as described above include a combination of an acrylic-based polymer to the side chain of which an acrylate group has been introduced and a compound having two or more functional groups (particularly acrylate groups) having a carbon-carbon double bond. As such a combination, it is possible to utilize a combination disclosed in Japanese Patent Laid-Open No. 2003-292916, or the like.

As a method for preparing the above-mentioned acrylic-based polymer to the side chain of which an acrylate group has been introduced, it is possible to use, for example, a method for coupling an isocyanate compound, such as acryloyl oxyethyl isocyanate or methacryloyl oxyethyl isocyanate, with an acrylic-based polymer containing a hydroxyl group in the side chain thereof, through an urethane bond.

The blended amount of the activated energy line-hardening compound is 0.5 to 200 pts. wt. or so, preferably 5 to 180 pts. wt., and more preferably within the range of 20 to 130 pts. wt. or so, with respect to, for example, a 100 pts. wt. of the base material (for example, an acrylic-based polymer chemically modified by the acrylic-based polymer or activated energy line-reactive functional group).

An activated energy line polymerization initiator for hardening a compound used to impart a activated energy line-hardening property may be blended with the activated energy line-hardening tackiness agent, with an aim to, for example, improve the rate of reaction for forming a three-dimensional mesh structure.

As the activated energy line polymerization initiator, a heretofore-known or commonly-used polymerization initiator can be selected as appropriate, according to the type of activated energy lines to be used (for example, infrared rays, visible light rays, ultraviolet rays, X-rays, or electron beams). From the viewpoint of work efficiency, a compound capable of initiating photopolymerization by ultraviolet rays is preferred. Typical examples of the activated energy line polymerization initiator include a ketone-based initiator, such as benzophenone, acetophenone, quinone, naphthoquinone, anthraquinone and fluorene; an azo-based initiator, such as azobisisobutyronitrile; and a peroxide-based initiator, such as benzoyl peroxide and perbenzoic acid, though not limited to these. Commercially-available products include “IRGACURE 184” (trade name) and “IRGACURE 651” (trade name) made by Ciba-Geigy.

The activated energy line polymerization initiator can be used independently or two or more types thereof can be mixed and used. The blended amount of activated energy line polymerization initiator is normally 0.01 to 10 pts. wt. or so, and preferably 1 to 8 pts. wt. or so, for a 100 pts. wt. of the abovementioned base material. Note that an activated energy line polymerization accelerator may be used along with the above-mentioned activated energy line polymerization initiator, as necessary.

In addition to the abovementioned components, appropriate additives are blended with the activated energy line-hardening tackiness agent, as necessary. That is, a cross-linking agent, a hardening (cross-linking) accelerator, a tackifier, a vulcanizing agent, a thickening agent, and the like are blended in order to obtain appropriate tackiness before and after activated energy line hardening. In addition, an anti-aging agent, an anti-oxidizing agent, and the like are blended in order to improve durability.

As a preferable activated energy line-hardening tackiness agent, there is used, for example, a composite in which an activated energy line-hardening compound is blended with a base material (tackiness agent), and preferably a UV-hardening tackiness agent in which a UV-hardening compound is blended with an acrylic-based tackiness agent. As a particularly preferable mode of the activated energy line-hardening tackiness agent, there is used a side-chain acrylate-containing acrylic tackiness agent, an acrylate-based cross-linking agent (poly(meth)acryloyl group-containing compound or polyfunctional acrylate), and a UV-hardening tackiness agent containing an ultraviolet photoinitiator. The side-chain acrylate-containing acrylic tackiness agent refers to an acrylic-based polymer to the side chain of which an acrylate group has been introduced. The same type of side-chain acrylate-containing acrylic tackiness agent as described above can be prepared and used in the same way as described above. The acrylate-based cross-linking agent refers to a low-molecular compound cited above as an example of the poly(meth)acryloyl group-containing compound. As the ultraviolet photoinitiator, it is possible to use those cited above as examples of typical activated energy line polymerization initiators.

As a tackiness agent composing the tackiness agent layer 4, it is also possible to use a non-activated energy line-hardening tackiness agent with the abovementioned acrylic-based tackiness agent as the base material thereof. In this case, a tackiness agent having tack strength lower than peeling stress at the time of producing cylindrical rolls is suitable. For example, it is possible to use a tackiness agent having a tack strength of 6.5 N/10 mm or lower (for example, 0.05 to 6.5 N/10 mm, preferably 0.2 to 6.5 N/10 mm), and particularly preferably 6.0 N/10 mm or lower (for example, 0.05 to 6.0 N/10 mm, preferably 0.2 to 6.0 N/10 mm), in a 180° peel test (room temperature (25° C.)) using a silicon mirror wafer as a adherend.

As such a non-activated energy line-hardening tackiness agent with the acrylic-based tackiness agent having such low tack strength as the base material thereof, there is preferably used an acrylic-based tackiness agent, or the like, in which a cross-linking agent [for example, an isocyanate-based cross-linking agent, a melamine-based cross-linking agent, or an epoxy-based cross-linking agent] capable of reacting with the reactive functional group is added to a copolymer comprised of: (meth)acrylate alkyl ester [for example, (meth)acrylate C₁-C₂₀ alkyl ester, such as methyl (meth)acrylate, ethyl(meth)acrylate, butyl (meth)acrylate, 2-ethylhexyl(meth)acrylate, or octyl (meth)acrylate]; a monomer having a reactive functional group [for example, a carboxyl group- or acid anhydride group-containing monomer, such as acrylic acid, methacrylic acid, itaconic acid, fumaric acid, or maleic acid anhydride; a hydroxyl group-containing monomer, such as 2-hydroxyethyl(meth)acrylate; an amino group-containing monomer, such as morpholyl(meth)acrylate; an amide group-containing monomer, such as amide (meth)acrylate]; and other copolymerizable monomers used as necessary [for example, (meth)acrylic acid ester or acrylonitrile having an alicyclic hydrocarbon radical such as isobornyl(meth)acrylate], thereby cross-linking the copolymer.

The tackiness agent layer 4 can be formed by a commonly-used method, for example, a method in which a coating liquid prepared by adding a tackiness agent, an activated energy line-hardening compound, and, as necessary, a solvent, is coated on a surface of the restriction layer 3 (on a surface of the rigid film layer 32 in the above-described example), or a method in which the abovementioned coating liquid is coated on an appropriate peeling liner (peeling liner) to form a tackiness agent layer, and this layer is transferred (moved) onto the restriction layer 3. In the case of a method based on transfer, voids (gaps) may remain in a boundary with the restriction layer 3. In this case, the voids can be dispersed and eliminated by performing a warming and pressurizing treatment, such as an autoclave treatment. The tackiness agent layer 4 may be composed of either a single layer or multiple layers.

Beads, such as glass beads or resin beads, may further be added to the constituent components of the tackiness agent layer 4. Adding glass beads or resin beads to the tackiness agent layer 4 increases the shear elastic modulus thereof and makes it easy to reduce the tack strength thereof. The average grain diameter of beads is, for example, 1 to 100 μm, and preferably 1 to 20 μm or so. The additive amount of beads is, for example, 25 to 200 pts. wt., and preferably 50 to 100 pts. wt, for a total 100 pts. wt. of the tackiness agent layer 4. If the additive amount is too large, dispersion failure may occur, thus possibly causing difficulty in coating a tackiness agent. If the additive amount is too small, the abovementioned advantageous effect tends to fall short.

The thickness of a tackiness agent layer 4 is generally 10 to 200 μm, preferably 20 to 100 μm, and more preferably 30 to 60 μm. If the abovementioned thickness is too small, the tackiness agent layer lacks in tack strength, thus tending to cause difficulty in holding or temporarily fixing the adherend. If the above-mentioned thickness is too large, the protection tape is uneconomical and inferior in handleability and is therefore not preferable.

The surface protection tape 1 used in the present invention can be manufactured by stacking the shrinkable film layer 2 and the restriction layer 3 (preferably, the elastic layer 31 and the rigid film layer 32), and laminating the stacked layers by selectively using laminating means, such as a hand roller or a laminator, and atmospheric-pressure compression means, such as an autoclave, as appropriate, according to intended purposes. Alternatively, the surface protection tape of the present invention may be manufactured by providing the tackiness agent layer 4 on a surface of the restriction layer 3 of the surface protection tape 1, or by stacking the restriction layer 3 (or the rigid film layer 32), on one surface of which the tackiness agent layer 4 has been previously provided, and the shrinkable film layer 2 (or the shrinkable film layer 2 and the elastic layer 31), and then laminating the stacked layers.

If the surface protection tape 1 has an activated energy line-hardening compound on a side in contact with the adherend 7, the tack strength of the tape can be reduced by irradiating activated energy lines to the side of the surface protection tape 1 in contact with the adherend 7, after bonding the surface protection tape 1 to the adherend 7 and performing dicing processing thereon. Subsequently or concurrently, heat for causing the contraction of the shrinkable film layer is applied to make the surface protection tape 1 spontaneously curl up in one direction from one end thereof (normally in the axial direction of primary contraction) or toward the center thereof from opposed two ends (normally in the axial direction of primary contraction), thereby forming one or two cylindrical rolls. Thus, the surface protection tape 1 can be separated off from the adherend 7. A contraction-inducing stimulus, such as heating, is preferably applied concurrently with activated energy line irradiation. Note that if the surface protection tape 1 self-rolls in a direction from one end thereof, one cylindrical roll is formed (unidirectional roll-up separation). If the surface protection tape 1 spontaneously curls up toward the center thereof from opposed two ends, two side-by-side cylindrical rolls are formed (bidirectional roll-up separation).

If, after dicing processing, a contraction-inducing stimulus, such as heating, is applied to the shrinkable film layer 2, by a predetermined means for applying the contraction-inducing stimulus, concurrently with or subsequently to irradiating the tackiness agent layer 4 with activated energy lines, in cases where the tackiness agent layer 4 is, for example, an activated energy line-hardening tackiness agent layer, then the tackiness agent layer 4 hardens and loses tack strength. Consequently, since the shrinkable film layer 2 attempts to contract and transform, the surface protection tape 1 lifts and curls up from the outer edges thereof (or the two opposed edges). Depending on the conditions of applying the contraction-inducing stimulus, such as heating, the surface protection tape 1 propels itself, while curling up further, in one direction or in two directions opposite each other (toward the center of the tape), thereby forming one or two cylindrical rolls. Here, the cylindrical roll includes not only those in which both ends of the tape have contact with or overlap with each other but also those in which both ends of the tape do not have contact with each other and part of the roll is open. Since, at this time, the contraction direction of a pressure-sensitive adhesive sheet is regulated by the restriction layer 3, the adhesive sheet promptly forms a cylindrical roll, while curling up in one axial direction. Accordingly, the surface protection tape 1 can be separated off from the adherend 7 extremely easily and neatly.

When applying the contraction-inducing stimulus by heating, heating temperature can be selected as appropriate, according to the contractility of the shrinkable film layer 2. A heating temperature, for example, an upper temperature limit is not limited in particular, as long as the temperature, for example, allows the tape to curl up without affecting the object to be cut. For example, the temperature can be set to 50° C. or higher, preferably 50° C. to 180° C., and more preferably 70° C. to 180° C. Activated energy line irradiation and heat treatment may be performed either simultaneously or stepwise. At the time of heating, the entire surface of the adherend may be warmed either uniformly or step by step. Alternatively, the adherend may be warmed partially only for the purpose of creating a trigger for separation. Thus, a heating method can be selected as appropriate, with an aim to take advantage of easy peeling properties.

### [Intermediate Layer]

A material for composing an intermediate layer is not limited in particular. It is possible to use, for example, a tackiness agent mentioned for the tackiness agent layer, various types of soft resins, such as polyethylene (PE), an ethylene-vinyl alcohol copolymer (EVA), and an ethylene-ethyl acrylate copolymer (EEA), generally referred to as resin films, resin formed of a mixture of acrylic-based resin and an urethane polymer, or a graft polymer of acrylic-based resin and natural rubber.

As the acrylic-based monomer for composing the abovementioned acrylic-based resin, it is possible to use, for example, alkyl ester of (meth)acrylate, such as C₁-C₂₀ alkyl ester of (meth)acrylate, including methyl (meth)acrylate, ethyl(meth)acrylate, butyl (meth)acrylate, t-butyl(meth)acrylate, 2-ethylhexyl (meth)acrylate, and octyl(meth)acrylate, either independently or by mixing any of these monomers with a monomer copolymerizable with the alkyl ester of (meth)acrylate [for example, a carboxyl group- or acid anhydride group-containing monomer, such as acrylic acid, methacrylic acid, itaconic acid, fumaric acid, or maleic acid anhydride].

Of these materials for composing the intermediate layer of the present invention, it is preferable to use the resin formed of a mixture of acrylic-based resin and an urethane polymer or the graft polymer of acrylic-based resin and natural rubber, from the viewpoint of adhesion to the rigid film layer. It is particularly preferable to use the resin formed of a mixture of acrylic-based resin and an urethane polymer. Note that the urethane polymer can be manufactured using a well-known commonly-used method.

An undercoat layer may be provided, as appropriate, between the intermediate layer and the rigid film layer, with an aim to enhance adhesiveness between the intermediate layer and the rigid film layer. In addition, it is possible to perform a commonly-used physical or chemical treatment as necessary, such as a matte treatment, a corona discharge treatment, a primer treatment, or a cross-linking treatment (for example, a chemical cross-linking treatment using silane), on a surface of the intermediate layer, with an aim to enhance adhesiveness between the intermediate layer and the tackiness agent layer.

The intermediate layer can be formed using a well-known commonly-used method, according to the material form thereof. If the material form exhibits, for example, a solution state, the intermediate layer can be formed by coating a solution of the intermediate layer on a surface of the rigid film layer. Alternatively, the intermediate layer can also be formed by coating the solution on an appropriate peeling liner (separator), and then transferring (moving) the intermediate layer onto the rigid film layer. If soft resin or mixed resin is used as the intermediate layer, methods for forming the intermediate layer include extrusion-laminating the resin onto the rigid film layer, dry-laminating a resin previously formed into a film state, and bonding the intermediate layer through an undercoating agent having tacky adhesiveness.

The shear elastic modulus of the intermediate layer at 23° C. is 1×10⁴ Pa to 4×10⁷ Pa or so, and preferably 1×10⁵ Pa to 2×10⁷ Pa or so, from the viewpoint of ease of bonding the pressure-sensitive adhesive sheet and workability, such as tape cutting. If the shear elastic modulus at 23° C. decreases below 1×10⁴ Pa, the intermediate layer may stick out from the outer circumference of the wafer due to the pressure of wafer grinding, thus causing damage to the wafer. If the shear elastic modulus at 23° C. increases above 4×10⁷ Pa, the function of the intermediate layer to suppress warpage tends to degrade.

The thickness of the intermediate layer is preferably 10 μm or larger, and more preferably 30 μm or larger (particularly preferably 50 μm or larger). If the thickness of the intermediate layer decreases below 10 μm, the intermediate layer tends to cause difficulty in effectively suppressing the warpage of the wafer due to grinding. In addition, the thickness of the intermediate layer is preferably smaller than 150 μm, in order to ensure grinding accuracy.

The intermediate layer preferably has not only the function of alleviating the abovementioned tensile stress but also the function of serving as a cushion for absorbing irregularity in a surface of the wafer during grinding. Accordingly, the sum of the thicknesses of the intermediate layer and the abovementioned tackiness agent layer is preferably 30 μm (particularly preferably 50 to 300 μm). On the other hand, if the sum of the thicknesses of the intermediate layer and the abovementioned tackiness agent layer decreases below 30 μm, the intermediate layer tends to fall short of tack strength with respect to the wafer and fails to absorb irregularity in a wafer surface at the time of bonding. Consequently, there arises the tendency that the wafer breaks during grinding or cracks occur at edges of the wafer. If the sum of the thicknesses of the intermediate layer and the abovementioned tackiness agent layer increases above 300 μm, thickness accuracy degrades. Consequently, there arises the tendency that the wafer breaks during grinding or self-rolling properties degrade.

A product of the shear elastic modulus and the thickness of the intermediate layer at, for example, 23° C. is 15000 N/m or smaller (for example, 0.1 to 15000 N/m), preferably 3000 N/m or smaller (for example, 3 to 3000 N/m), and particularly preferably 1000 N/m or smaller (for example, 20 to 1000 N/m). If the product of the shear elastic modulus and the thickness of the intermediate layer is too large, it is difficult to alleviate the tensile stress of a composite base material composed of the shrinkable film layer, the elastic layer and the rigid film layer. This tends to cause difficulty in suppressing the warpage of the wafer due to grinding. In addition, the rigidity of the composite base material prevents the material from fully absorbing irregularity in a wafer surface at the time of bonding. Consequently, there arises the tendency that the wafer breaks during grinding or cracks occur at edges of the wafer. If the product of the shear elastic modulus and the thickness of the intermediate layer is too small, the intermediate layer may stick out from the wafer. Thus, the wafer is liable to crack at edges thereof or break down. In addition, such a small thickness also has the effect of degrading roll-up properties.

### [Activated Energy Line-Hardening Tackiness Agent Layer]

Before activated energy line irradiation, the activated energy line-hardening tackiness agent layer 33 has tack strength sufficient to protect an adherend from suffering “breakage” or “cracking,” when bonded to the adherend. After processing, the tackiness agent layer can be made to form a three-dimensional mesh structure and become hardened by irradiating the tackiness agent layer with activated energy lines, such as infrared rays, visible light rays, ultraviolet rays, X-rays, or electron beams. Thus, it is possible to reduce the tack strength of the tackiness agent layer with respect to the adherend. In addition, when the shrinkable film layer contracts due to heat, the tackiness agent layer can produce effects as a restriction layer for repelling such contraction. Consequently, this repulsive force against the contraction serves as a driving force to raise the outer edge or edges (ends) of a surface protection tape. Thus, the surface protection tape spontaneously curls up, with the shrinkable film layer facing inward, in one direction from one end of the tape or toward the center thereof (center of the two ends) from two opposed ends. Consequently, the surface protection tape can form one or two cylindrical rolls.

A tackiness agent for forming the activated energy line-hardening tackiness agent layer 33 preferably contains at least a compound chemically modifying an activated energy line-reactive functional group for imparting an activated energy line-hardening property, or an activated energy line-hardening compound (or activated energy line-hardening resin). Accordingly, as the activated energy line-hardening tackiness agent, a tackiness agent composed of a base material chemically modified by the activated energy line-reactive functional group and/or a composite, in which the activated energy line-hardening compound (or the activated energy line-hardening resin) is blended with the base material, is preferably used.

As the abovementioned base material, it is possible to use a sticky substance, such as a heretofore-known pressure-sensitive adhesive agent (tackiness agent). For the tackiness agent, a rubber-based tackiness agent using a rubber-based polymer, such as natural rubber, polyisobutylene rubber, styrene-butadiene rubber, styrene-isoprene-styrene block copolymer rubber, reclaimed rubber, butyl rubber, polyisobutylene rubber or NBR, as the base polymer thereof; a silicone-based tackiness agent; and an acrylic-based tackiness agent are cited as examples. Of these tackiness agents, the acrylic-based tackiness agent is preferred. The base material may be composed of one or more than one type of component.

For the acrylic-based tackiness agent, there is cited, as an example, an acrylic-based tackiness agent using, as the base polymer thereof, an acrylic-based polymer, such as a monomer or a copolymer of alkyl ester of (meth)acrylate, such as C₁-C₂₀ alkyl ester of (meth)acrylate, including methyl(meth)acrylate, ethyl (meth)acrylate, butyl(meth)acrylate, 2-ethylhexyl (meth)acrylate, and octyl(meth)acrylate; and a copolymer composed of the alkyl ester of (meth)acrylate and other copolymerizable monomers [for example, a carboxyl group or an acid anhydride group-containing monomer, such as acrylic acid, methacrylic acid, itaconic acid, fumaric acid, or maleic acid anhydride; a hydroxyl group-containing monomer, such as 2-hydroxyethyl (meth)acrylate; an amino group-containing monomer, such as morpholyl(meth)acrylate; and an amide group-containing monomer, such as amide(meth)acrylate]. One type of these tackiness agents can be used independently or two or more types can be used in combination.

The activated energy line-reactive functional group and the activated energy line-hardening compound used for chemical modification to cause activated energy line-induced hardening are not limited in particular, as long as the group and compound can be hardened by activated energy lines, such as infrared rays, visible light rays, ultraviolet rays, X-rays or electron beams. However, the group and compound are preferably of such a type that the tackiness agent is efficiently reticulated three-dimensionally (turned into a mesh structure) by activated energy line irradiation. One type of these groups and compounds can be used independently or two or more types can be used in combination.

Examples of the activated energy line-reactive functional group used for chemical modification include, for example, a functional group having a carbon-carbon multiple bond, such as an acryloyl group, a methacryloyl group, a vinyl group, an allyl group, and an acetylenic group. These functional groups generate radicals as the carbon-carbon multiple bond is cleaved by activated energy line irradiation. These radicals serve as cross-linking points to enable the functional groups to form a three-dimensional mesh structure. Of these groups, the acryloyl group or the methacryloyl group is preferred from the viewpoint of reactiveness and workability, as the group can exhibit comparatively high reactivity with respect to activated energy lines and can be used in combination by selecting from a wide variety of acrylic-based tackiness agents.

Typical examples of the base material chemically modified by an activated energy line-reactive functional group include a polymer obtained by reacting a compound [for example, (meth)acryloyl oxyethylene isocyanate] having within the molecule thereof a group (an isocyanate group, an epoxy group, or the like) and an activated energy line-reactive functional group (an acryloyl group, a methacryloyl group, or the like) reactive with the abovementioned reactive functional group, with a reactive functional group-containing acrylic-based polymer in which a monomer containing a reactive functional group, such as a hydroxyl group or a carboxyl group [for example, 2-hydroxyethyl(meth)acrylate or (meth)acrylate] is copolymerized with alkyl ester of (meth)acrylate.

The ratio of the monomer containing the reactive functional group in the abovementioned reactive functional group-containing acrylic-based polymer is, for example, 5 to 40 wt %, and preferably 10 to 30 wt %, to all monomers. The amount used of compound having within the molecule thereof the group and the activated energy line-reactive functional group reactive with the reactive functional group when reacted with the above-mentioned reactive functional group-containing acrylic-based polymer is, for example, 50 to 100 mole %, and preferably 60 to 95 mole %, with respect to the reactive functional group (a hydroxyl group, a carboxyl group, or the like) in the reactive functional group-containing acrylic-based polymer.

Examples of the activated energy line-hardening compound include, for example, a compound having within the molecule thereof two or more groups containing carbon-carbon double bonds, such as acryloyl and methacryloyl groups, including trimethylolpropane tetraacrylate, tetramethylolmethane tetraacrylate, pentaerythritol triacrylate, pentaerythritol tetraacrylate, dipentaerythritol monohydroxy pentaacrylate, dipentaerythritol hexaacrylate, 1,4-butane diol diacrylate, 1,6-hexane diol diacrylate, and polyethylene glycol diacrylate. These compounds may be used independently or two or more types of the compounds may be used in combination. Of these compounds, a compound having two or more acryloyl and/or methacryloyl groups is preferred, and is cited as an example in, for example, Japanese Patent Laid-Open No. 2003-292916.

As the activated energy line-hardening compound, it is also possible to use, for example, a mixture of organic salt, such as onium salt, and a compound having within the molecule thereof a plurality of heterocyclic rings. The abovementioned mixture can form a three-dimensional mesh structure as the result that organic salt is cleaved by activated energy line irradiation to generate ions, and these ions serve as initiation seeds for triggering the ring-opening reaction of heterocyclic rings. The organic salts include iodonium salt, phosphonium salt, antimonium salt, sulfonium salt, and borate salt. The heterocyclic rings in the compound having within the molecule thereof a plurality of heterocyclic rings include oxirane, oxetane, oxolane, thiirane, and aziridine. Specifically, it is possible to use compounds and the like described in Light Cure Technologies (2000) compiled by Technical Information Institute Co., Ltd.

Examples of the activated energy line-hardening resin include, for example, a polymer or oligomer having within the molecule thereof an acryloyl or methacryloyl group, such as ester (meth)acrylate, urethane (meth)acrylate, epoxy(meth)acrylate, melamine (meth)acrylate, or acrylic resin (meth)acrylate; thiol-ene added resin and cationic photopolymerization-type resin having within the molecule thereof an aryl group; a cinnamoyl group-containing polymer, such as polyvinyl cinnamate; and a photosensitive reactive group-containing polymer or oligomer, such as diazotized amino novolac resin, and an acrylamide type polymer. Examples of polymers reactive to higher-activated energy lines include epoxidized polybutadiene, unsaturated polyester, polyglycidyl methacrylate, polyacrylamide, and polyvinyl siloxane. Note that if an activated energy line-hardening resin is used, the abovementioned base material is not necessarily be needed.

The molecular weight of an activated energy line-hardening resin is, for example, less than 5000 or so, and preferably 100 to 3000. If the molecular weight of the activated energy line-hardening resin is greater than 5000, compatibility with an acrylic-based polymer (which is the base material) tends to degrade, for example.

As the activated energy line-hardening resin, it is preferable to use an oligomer having within the molecule thereof an acryloyl or methacryloyl group, such as ester (meth)acrylate, urethane (meth)acrylate, epoxy (meth)acrylate, melamine(meth)acrylate, or acrylic resin (meth)acrylate, from the viewpoint that the resin can exhibit comparatively high reactivity to activated energy lines.

As the activated energy line-hardening tackiness agent, it is preferable to use, in combination, a compound chemically modifying an activated energy line-reactive functional group for imparting an activated energy line-hardening property, and an activated energy line-hardening compound (or activated energy line-hardening resin), from the viewpoint that these compounds offer a wide choice and are easy to make elastic modulus adjustments before and after activated energy line irradiation. In particular, a combination of an acrylic-based polymer to the side chain of which a (meth)acryloyl group has been introduced and an oligomer having within the molecule thereof an acryloyl or methacryloyl group is preferred, from the viewpoint of reactiveness and workability, since the combination contains a (meth)acryloyl group exhibiting comparatively high reactivity to activated energy lines, and can be selected from a variety of acrylic-based tackiness agents. As such a combination, it is possible to utilize a combination disclosed in Japanese Patent Laid-Open No. 2003-292916, or the like.

The blended amount of the activated energy line-hardening resin (for example, an oligomer having within the molecule thereof an acryloyl or methacryloyl group) is 0.5 to 200 pts. wt. or so, preferably 5 to 180 pts. wt., and more preferably within the range of 20 to 130 pts. wt. or so, with respect to, for example, a 100 pts. wt. of the base material (for example, an acrylic-based polymer to the side chain of which a (meth)acryloyl group has been introduced.

An activated energy line polymerization initiator for hardening a compound used to impart an activated energy line-hardening property may be blended with the activated energy line-hardening tackiness agent, with an aim to improve the rate of reaction for forming a three-dimensional mesh structure.

As the activated energy line polymerization initiator, a heretofore-known or commonly-used polymerization initiator can be selected as appropriate, according to the type of activated energy lines to be used (for example, infrared rays, visible light rays, ultraviolet rays, X-rays, or electron beams). From the viewpoint of work efficiency, a compound capable of initiating photopolymerization by ultraviolet rays is preferred. Typical examples of the activated energy line polymerization initiator include a ketone-based initiator, such as benzophenone, acetophenone, quinone, naphthoquinone, anthraquinone and fluorene; an azo-based initiator, such as azobisisobutyronitrile; and a peroxide-based initiator, such as benzoyl peroxide and perbenzoic acid, though not limited to these. Commercially-available products include “IRGACURE 184” (trade name) and “IRGACURE 651” (trade name) made by Ciba-Geigy Japan Ltd.

The activated energy line polymerization initiator can be used independently or two or more types thereof can be mixed and used. The blended amount of activated energy line polymerization initiator is normally 0.01 to 10 pts. wt. or so, and preferably 1 to 8 pts. wt. or so, with respect to 100 pts. wt. of the abovementioned base material. Note that an activated energy line polymerization accelerator may be used along with abovementioned activated energy line polymerization initiator, as necessary.

Beads, such as glass beads or resin beads, may further be added to the constituent components of the activated energy line-hardening tackiness agent layer. Adding glass beads or resin beads to the activated energy line-hardening tackiness agent layer increases the shear elastic modulus thereof and makes it easy to reduce the tack strength thereof. The average grain diameter of beads is, for example, 1 to 100 μm, and preferably 1 to 20 μm or so. The additive amount of beads is, for example, 25 to 200 pts. wt., and preferably 50 to 100 pts. wt, with respect to a total 100 pts. wt. of the activated energy line-hardening tackiness agent layer. If the additive amount is too large, dispersion failure may occur, thus possibly causing difficulty in coating a tackiness agent. If the additive amount is too small, the abovementioned advantageous effect tends to fall short.

In addition to the abovementioned components, appropriate additives are blended with the activated energy line-hardening tackiness agent, as necessary. That is, a cross-linking agent, a hardening (cross-linking) accelerator, a tackifier, a vulcanizing agent, a thickening agent, and the like are blended, in order to obtain appropriate tackiness before and after activated energy line hardening. In addition, an anti-aging agent, an anti-oxidizing agent, and the like are blended in order to improve durability.

As a particularly preferable mode of the activated energy line-hardening tackiness agent, there is used a side-chain (meth)acryloyl group-containing acrylic tackiness agent, an oligomer having within the molecule thereof an acryloyl or methacryloyl group, an acrylate-based cross-linking agent (poly(meth)acryloyl group-containing compound or polyfunctional acrylate), and a UV-hardening tackiness agent containing an ultraviolet photoinitiator.

An activated energy line-hardening tackiness agent layer can be formed by a commonly-used method, for example, a method in which a coating liquid prepared by adding a tackiness agent, an activated energy line-hardening compound, and, as necessary, a solvent, is coated on a surface of the abovementioned shrinkable film layer, or a method in which the abovementioned coating liquid is coated on an appropriate peeling liner (peeling liner) to form an activated energy line-hardening tackiness agent layer, and this layer is transferred (moved) onto the shrinkable film layer. In the case of a method based on transfer, voids (gaps) may remain in a boundary with the shrinkable film layer. In this case, the voids can be dispersed and eliminated by performing a warming and pressurizing treatment, such as an autoclave treatment. The activated energy line-hardening tackiness agent layer may be composed of either a single layer or multiple layers.

The thickness of the activated energy line-hardening tackiness agent layer is generally 10 to 400 μm (for example, 20 to 300 μm), preferably 20 to 200 μm, and more preferably 30 to 100 μm. If the abovementioned thickness is too small, the tackiness is insufficient, thus tending to cause difficulty in holding or temporarily fixing the adherend. If the abovementioned thickness is too large, the protection tape is uneconomical and tends to be inferior in handleability.

Before activated energy line irradiation, a product of the tensile elastic modulus and thickness of the activated energy line-hardening tackiness agent layer 33 at normal temperature (25° C.) is 0.1 to 100 N/m or so, and preferably 0.1 to 20 N/m. The tack strength (180° peel-off applied to a silicon mirror wafer at a tensile rate of 300 mm/min) of the tackiness agent layer is preferably, for example, within the range of 0.5 to 10 N/10 mm at normal temperature (25° C.). If the product of the tensile elastic modulus and thickness before activated energy line irradiation and the tack strength fall outside the abovementioned range, the tackiness agent layer 33 lacks in tack strength. Thus, the tackiness agent layer 33 tends to cause difficulty in holding and temporarily fixing the adherend.

The activated energy line-hardening tackiness agent layer 33 is characterized in that, when irradiated with activated energy lines, the tackiness agent layer becomes hardened, and the product of the tensile elastic modulus and thickness thereof at 80° C. is 5×10³ N/m or larger but smaller than 1×10⁵ N/m (preferably 8×10³ N/m or larger but smaller than 1×10⁵ N/m). If the product of the tensile elastic modulus and thickness after activated energy line irradiation decreases below 5×10³ N/m, an adequate amount of counteracting force does not arise. Consequently, the surface protection tape transforms into an indeterminate form;—for example, the tape as a whole bends or becomes undulate (rumpled) due to the contraction stress of the heat-shrinkable film, thus failing to initiate self-rolling up.

The activated energy line-hardening tackiness agent layer 33 can be hardened by irradiating the layer with activated energy lines, so that the product of the tensile elastic modulus and thickness at 80° C. is 5×10³ N/m or larger but smaller than 1×10⁵ N/m. Thus, the tackiness agent layer 33 has moderate toughness or rigidity after activated energy line irradiation, and can produce effects as a restriction layer. By this restriction layer, the shrinkable film layer is restricted from contracting due to heat, thereby enabling generation of a counteracting force. This makes it possible for the laminated body 15 of FIG. 8 as a whole, for example, to create a force couple. Thus, the force couple can be utilized as a driving force for causing rolling-up.

In addition, secondary contraction in directions different from the direction of primary contraction of the shrinkable film layer 2 is suppressed. Thus, the shrinkable film layer 2 is considered to also serve to allow the contraction directions of the layer, whose contractility, though considered uniaxial, cannot be necessarily said to be uniform, to converge on one direction. Accordingly, if heat for facilitating the contraction of a shrinkable film layer is applied to, for example, the laminated body 15 of FIG. 8, the repulsive force against the contraction force of the shrinkable film layer 2 in the post-hardening, activated energy line-hardening tackiness agent layer 33 for producing effects as a restriction layer serves as a driving force, thus causing an outer edge or edges of the laminated body 15 (one end or two opposed ends) to rise. It is therefore considered that the laminated body 15 spontaneously curls up in one direction or toward the center thereof from an end or ends thereof (normally, in the axial direction of primary contraction of the shrinkable film layer 2) with the shrinkable film layer 2 side facing inward, thereby forming a cylindrical roll or rolls.

In addition, warpage arising in a wafer after grinding is considered to occur because stress produced when an adhesive sheet is bonded to the wafer remains, and the shrinkable film layer becomes elastically deformed by this residual stress. The elastic layer can also produce the effect of alleviating this residual stress and lower the degree of warpage. With the post-hardening, activated energy line-hardening tackiness agent layer 33 which produces effects as a restriction layer, it is also possible to prevent a shear force produced by the contractive transformation of the shrinkable film layer from being transmitted to the adherend. Consequently, it is possible to prevent the breakage of the adherend at the time of separation. Furthermore, the activated energy line-hardening tackiness agent layer 33, as the result of becoming hardened, remarkably degrades in tack strength with respect to the adherend. Thus, the tackiness agent layer 33 can be easily separated off, without leaving any adhesive deposits on the adherend at the time of separation.

The surface protection tape in the present invention can be manufactured preferably by stacking the shrinkable film layer 2 and the activated energy line-hardening tackiness agent layer 33, and laminating the stacked layers by selectively using laminating means, such as a hand roller or a laminator, and atmospheric-pressure compression means, such as an autoclave, as appropriate, according to intended purposes.

Examples of activated energy lines can include, for example, infrared rays, visible light rays, ultraviolet rays, radioactive rays, and electron beams. Activated energy lines can be selected as appropriate, according to the type of activated energy line-hardening tackiness agent layer of a surface protection tape to be used. For example, if a surface protection tape having an ultraviolet ray-hardening tackiness agent layer is used, then ultraviolet rays are used as the activated energy lines.

A method for generating ultraviolet rays is not limited in particular, but a well-known commonly-used generation method can be used. It is possible to mention, for example, a discharge lamp (arc lamp) method, a flash method, and a laser method. In the present invention, it is preferable to use the discharge lamp (arc lamp) method from the viewpoint of being superior in industrial productivity. It is particularly preferable to use an irradiation method using a high-pressure mercury lamp or a metal halide lamp, from the viewpoint of being superior in irradiation efficiency.

As the wavelength of ultraviolet rays, it is possible to use a wavelength in the ultraviolet region without any particular limitation. However, as a wavelength used in common photopolymerization and in the abovementioned method of ultraviolet generation, it is preferable to use a wavelength of 250 to 400 nm or so. Ultraviolet irradiation conditions are optional, as long as it is possible to initiate the polymerization of a tackiness agent composing the activated energy line-hardening tackiness agent layer, and harden the tackiness agent layer, so that a product of the tensile elastic modulus and thickness thereof at 80° C. is 5×10³ N/m or larger but smaller than 1×10⁵ N/m. The intensity of ultraviolet irradiation is, for example, 10 to 1000 mJ/cm² or so, and preferably 50 to 600 mJ/cm² or so. If the ultraviolet irradiation intensity falls below 10 mJ/cm², the activated energy line-hardening tackiness agent layer does not harden sufficiently, thus tending to have difficulty producing effects as a restriction layer. On the other hand, if the irradiation intensity rises above 1000 mJ/cm², the activated energy line-hardening tackiness agent layer tends to become excessively hardened, thus becoming cracked.

### [Peeling Liner]

In the surface protection tape 1 used in the present invention, a peeling liner 5 (separator) may be provided on a surface of the tackiness agent layer 4 or activated energy line-hardening tackiness agent layer 33, from the viewpoint of smoothing and protection of the tackiness agent layer 4 or the activated energy line-hardening tackiness agent layer 33 on a surface of the tape, label processing, antiblocking, and the like. The peeling liner 5 is separated off when the tape is bond to an adherend, and therefore, may not necessarily be provided. The peeling liner 5 to be used is not limited in particular, but it is possible to use a heretofore-known, commonly-used release paper or the like.

As the peeling liner 5, it is possible to use, for example, a base material having a releasing treatment layer, a low-adhesiveness base material composed of a fluorine-based polymer, or a low-adhesiveness base material composed of a nonpolar polymer. Examples of the abovementioned base material having a releasing treatment layer include, for example, a plastic film and a paper surface-treated with a silicone-based, long-chain alkyl-based, fluorine-based or molybdenum sulfide-based releasing treatment agent.

Examples of the fluorine-based polymer in the abovementioned low-adhesiveness base material composed of the fluorine-based polymer include, for example, polytetrafluoroethylene, polychlorotrifluoroethylene, polyvinyl fluoride, polyvinylidene fluoride, tetrafluoroethylene-hexafluoropropylene copolymer, and chlorofluoroethylene-vinylidene fluoride copolymer.

Examples of the nonpolar polymer in the abovementioned low-adhesiveness base material composed of the nonpolar polymer include, for example, olefin-based resin (for example, polyethylene and polypropylene). Note that the peeling liner can be formed using a heretofore-known or commonly-used method.

The thickness of the abovementioned peeling liner 5 is not limited in particular but is, for example, 10 to 200 μm, and preferably 25 to 100 μm or so. In addition, an ultraviolet rays protective treatment or the like may be performed on the peeling liner as necessary, in order to prevent the activated energy line-hardening tackiness agent layer from being hardened by environmental ultraviolet rays.

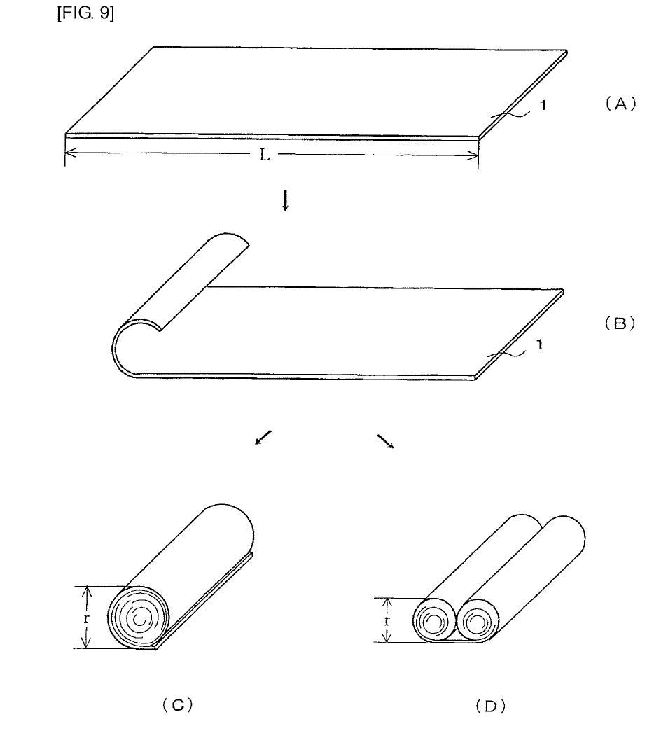

FIG. 9 illustrates the way in which a surface protection tape used in the present invention curls up by itself. In FIG. 9, reference character (A) denotes a view illustrating the surface protection tape 1 before a contraction-inducing stimulus, such as heat, is applied to the shrinkable film layer thereof. Reference character (B) denotes a view illustrating a state in which a surface protection tape (or an adhesive sheet after an activated energy line-hardening tackiness agent layer has hardened and the tack strength thereof has reduced, if the tape has the activated energy line-hardening tackiness agent layer), to the shrinkable film layer of which a contraction-inducing stimulus, such as heat, has been applied, begins to curl up in one direction (normally, in the axial direction of primary contraction of the shrinkable film layer) from an outer edge (one end) of the sheet. Reference character (C) denotes a view illustrating a state in which the sheet has finished curling up, thus forming one cylindrical roll (unidirectional rolling-up). In addition, reference character (D) is a view illustrating a state in which the sheet spontaneously curls up toward the center thereof from opposed two ends (normally, in the axial direction of primary contraction of the shrinkable film layer), thereby forming two cylindrical rolls (bidirectional rolling-up).

Note that whether the adhesive sheet causes unidirectional rolling-up or bidirectional rolling-up depends on the tack force of an activated energy line-hardening tackiness agent layer (a tackiness agent layer functioning as a restriction layer) after activated energy line irradiation with respect to the shrinkable film layer, the product of the tensile elastic modulus and thickness of the activated energy line-hardening tackiness agent layer, and the like, if the sheet has the activated energy line-hardening tackiness agent layer.

In FIG. 9, L denotes the length (or the diameter, if the sheet is circular) of the surface protection tape in the rolling-up direction thereof (normally, in the axial direction of primary contraction of the shrinkable film layer) (FIG. 9A), and r denotes the diameter (or the maximum diameter, if the diameter of the cylindrical roll is not constant in the length direction thereof, as in the case where the sheet is circular) of a formed cylindrical roll (FIGS. 9C and 9D). In the surface protection tape of the present invention, a value of r/L is defined by later-described working examples, and is preferably within the range of 0.001 to 1. Note that L can be set to, for example, 3 to 2000 mm, and preferably 3 to 1000 mm. Also note that a laminated sheet having no tackiness agent layers exhibits behaviors similar in self-rolling properties to those of an adhesive sheet having a tackiness agent layer.

A length of the adhesive sheet in a direction orthogonal to L can be set to, for example, 3 to 2000 mm, and preferably 3 to 1000 mm or so. The value of r/L can be set to within the abovementioned range by adjusting the material types, compositions, thicknesses and the like of the shrinkable film layer 2, the restriction layer 3 (elastic layer 31 and rigid film layer 32), and the tackiness agent layer 4, particularly the shear elastic modulus and the thickness of the elastic layer 31 composing the restriction layer 3 and the Young's modulus and thickness the rigid film layer 32. Likewise, the value of r/L can be set to within the above-mentioned range by adjusting the material types, compositions, thicknesses and the like of the shrinkable film layer and an activated energy line-hardening tackiness agent layer, particularly the tensile elastic modulus and the thickness of the activated energy line-hardening tackiness agent layer after activated energy line irradiation (a tackiness agent layer functioning as a restriction layer), if the sheet has the activated energy line-hardening tackiness agent layer. Although the surface protection tape in this example is quadrangular in shape, the surface protection tape is not limited to this shape. The shape can be selected as appropriate, according to the purpose of use, and may be either circular, elliptical, polygonal, or the like.

Note that the surface protection tape used in the present invention also curls up in the same way, even if the length L in the rolling-up direction of the sheet is increased. Accordingly, the lower limit of a ratio (r/L) of the diameter r of a cylindrical roll, which is formed when the surface protection tape is contracted by applying a contraction-inducing stimulus, such as heating, thereto, so as to make the tape spontaneously curl up, to the length L in the rolling-up direction of the surface protection tape becomes smaller with an increase in the length L in the rolling-up direction of the sheet.

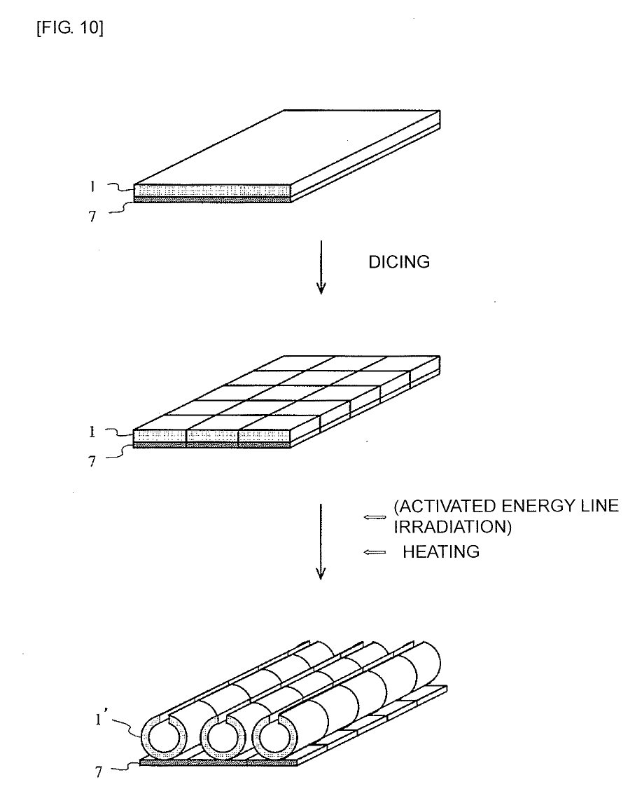

FIG. 10 illustrates one example of the way in which the surface protection tape 1 is bonded to the adherend 7, is diced together with the adherend 7, and then curls up by itself. As illustrated in FIG. 10, the surface protection tape 1 transforms into cylindrical rolls having a given diameter, upon application of a contraction-inducing stimulus, such as heating. Note that if the surface protection tape 1 has an activated energy line-hardening tackiness agent layer or the like, activated energy line irradiation may be performed previously to, or simultaneously with, applying the contraction-inducing stimulus, such as heating.

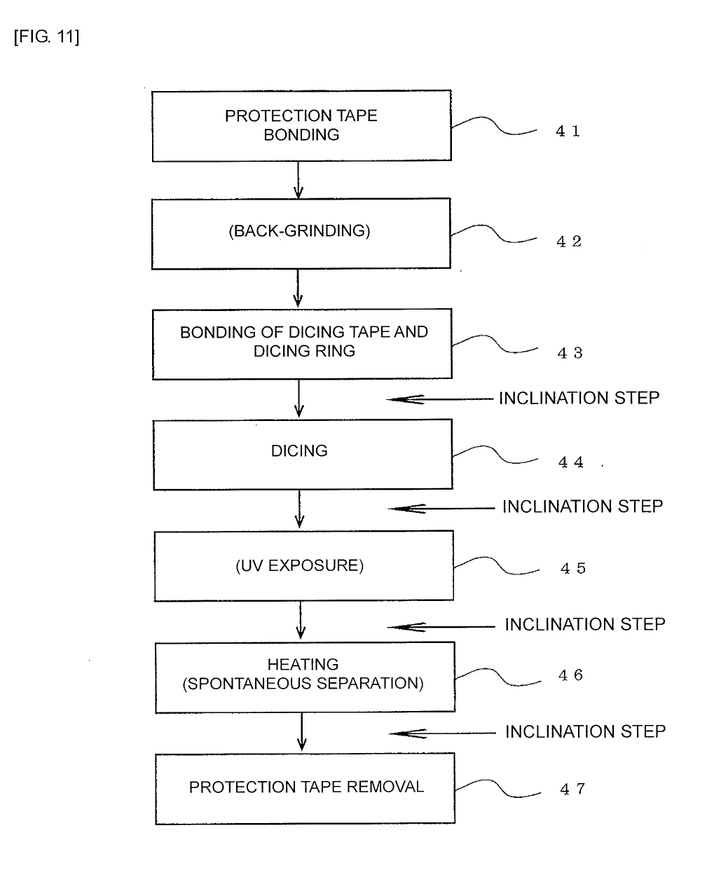

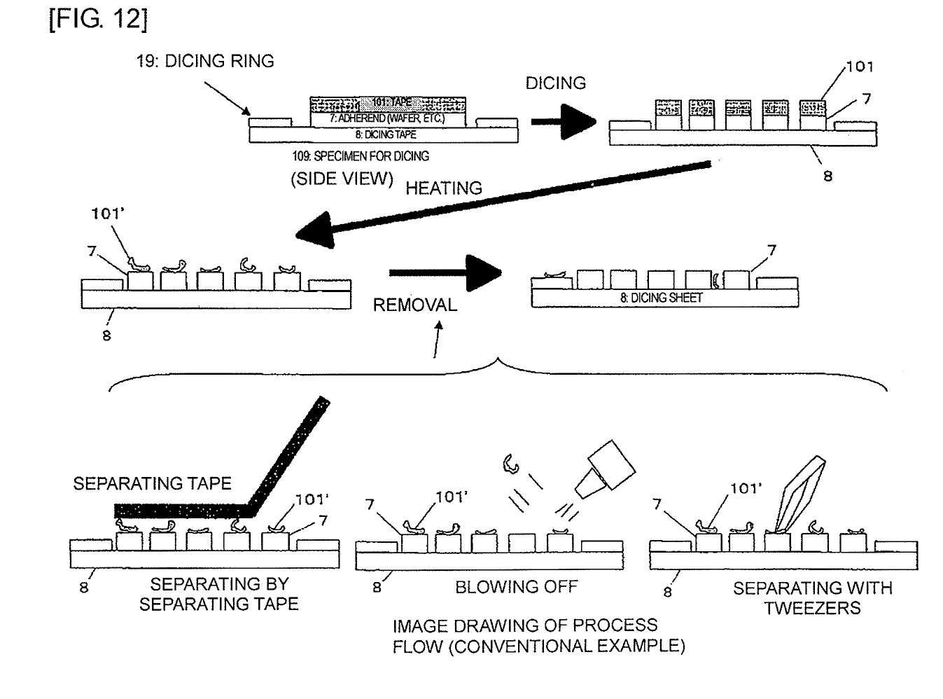

FIG. 11 shows one example of a flow of chip formation using a method of the present invention. First, a surface protection tape is bonded to an adherend (step 41). Subsequently, if the adherend is a semiconductor wafer, the adherend may be back-ground (step 42). Step 42 is carried out, in some cases, if the adherend is a semiconductor wafer, but may not be carried out. Next, a dicing tape and a dicing ring are bonded to a surface of the adherend opposite to the surface to which the surface protection tape is bonded (step 43). However, the dicing ring may not be bonded.

Following step 43, dicing is performed (step 44). Next, UV exposure is performed if a UV-hardening tackiness agent is used in the surface protection tape (step 45). Note that UV exposure may not be performed. Subsequently, heating, for example, is performed in order to cause the surface protection tape to separate off from the adherend by means of self-rolling up (step 46). A heating method is not restricted in particular, but a hot plate, a heat gun, an infrared lamp or the like can be used as appropriate. Note that heating is performed before pick-up (together with the dicing tape). Alternatively, the adherend is inclined before and after the heating step. Following the step, portions of the surface protection tape which have curled up by themselves and separated off from the adherend are removed (step 47). A method of removal is not limited in particular. Examples of the method include, for example, blowing off and suctioning the tape. In addition, a step of inclining an object to be cut needs to provided at one or more than one optional stage between step 43 and step 47.

If a surface protection tape preferably used in the present invention is used at the time of dicing the adherend, it is possible to avoid the breakage of the adherend due to stress at the time of separation. Thus, it is possible to simply and readily separate and remove the surface protection tape from the adherend, without damaging or contaminating the adherend, for example, even when dicing a fragile adherend, such as a thin semiconductor wafer.

### Working Examples

Hereinafter, a surface protection tape used in a method of the present invention will be described in detail, according to working examples. However, the present invention is not limited to these working examples in which the surface protection tape is used. Note that the shear elastic moduli of an elastic layer and a rigid film layer and the tack strength of the elastic layer with respect to a shrinkable film were measured as described below. In addition, r/L, which is an index for determining whether the surface protection tape functions as a cylindrical roll or rolls, was defined by a method described below.

### [Measurement of Rigid Film Layer's Young's Modulus (80° C.)]

The Young's modulus of the rigid film layer was measured in compliance with JIS K7127 by using the below-described method. As a tensile tester, Autograph AG-1kNG (with a warming hood) made by Shimadzu was used. A rigid film cut out to a 200 mm-long×10 mm-wide size was attached with an inter-chuck distance of 100 mm. After setting the rigid film to an ambient temperature of 80° C. by using the warming hood, the specimen was stretched at a tensile rate of 5 mm/min and a measured value of stress-strain relation was obtained. Loads at two points having strains of 0.2% and 0.45% were evaluated and, thus, the Young's modulus was obtained. This measurement was repeated five times for the same specimen and an average of the measured values was adopted.

### [Measurement of Elastic Layer's Shear Elastic Modulus (80° C.)]

The shear elastic modulus of the elastic layer was measured by the below-described method. After fabricating an elastic layer described in each of working and comparative examples to a thickness of 1.5 mm to 2 mm, the elastic layer was punched out with a puncher, 7.9 mm in diameter, thereby obtaining a specimen for measurement. The specimen was measured using a viscoelastic spectrometer (ARES) made by Rheometric Scientific with the chuck pressure thereof set to 100 gram-weight and the shear thereof to a frequency of 1 Hz [a stainless steel 8 mm parallel plate (Model 708.0157 made by TA Instruments) was used]. In addition, the shear elastic modulus of the specimen at 80° C. was measured.

[Measurement of Elastic Layer's Tack Strength with Respect to Shrinkable Film]

The tack strength of the elastic layer with respect to the shrinkable film was measured by a 180° peel test (50° C.). A laminated sheet [which was fabricated in the same way as an adhesive sheet, except that a tackiness agent layer (an activated energy line-hardening tackiness agent layer or a non-activated energy line-hardening tackiness agent layer) is not provided in the laminated sheet, or which was obtained after having been irradiated with ultraviolet rays at an intensity of 500 mJ/cm², if the sheet contained an ultraviolet-reactive cross-linking agent in the elastic layer but not yet had been irradiated with ultraviolet rays] was cut to a 10 mm-wide size. Then, a surface of the sheet on the side of a rigid film layer (denoted by reference numeral 22 in FIG. 1) was bonded to a rigid supporting base material (silicon wafer) by using a tacky tape, and a tensile jig of the peel tester was bonded to a surface of the sheet on the shrinkable film layer side by using a tacky tape. This specimen was mounted on a 50° C. warming stage (heater), so that the rigid supporting base material came into contact with the warming stage. The tensile jig was pulled in a 180° direction at a tensile rate of 300 mm/min, to measure a force (N/10 mm) when separation took place between the shrinkable film layer and the elastic layer. Note that, in order to eliminate measurement errors due to a difference in the thickness of the rigid supporting base material, measured data was normalized by regarding the thickness of the rigid supporting base material as being 38 μm.

[Measurement of Non-Activated Energy Line-Hardening Tackiness Agent Layer's Tack Strength with Respect to Silicon Mirror Wafer]

Laminated bodies of two types of non-activated energy line-hardening tackiness agents obtained in the below-described Manufacturing Examples 2 and 4 were bonded to a polyethylene terephthalate base material (38 lam in thickness) by using a hand roller. This specimen was cut to a size of 10 mm in width and, after the removal of a separating sheet, was bonded to a 4-inch mirror silicon wafer (made by Shin-Etsu Handotai under the trade name “CZ-N”) by using a hand roller. This specimen was bonded to the tensile jig of the peel tester by using a tacky tape. The tensile jig was pulled in a 180° direction at a tensile rate of'300 mm/min, to measure a force (N/10 mm) when separation took place between the shrinkable film layer and the elastic layer.

Note that for activated energy line-hardening tackiness agent layers obtained in the below-described Manufacturing Examples 1 and 3, tack strength with respect to the 4-inch mirror silicon wafer (made by Shin-Etsu Handotai under the trade name “CZ-N”) was also measured in the same way as described above, except that the tackiness agent layers were subjected to 500 mJ/cm² ultraviolet exposure prior to measurement. As a result, in every tackiness agent, the tack strength decreased to a level low enough for the layers to separate off at a force of 0.3 N/10 mm or smaller. Accordingly, in the below-described working examples, no descriptions will be given of the tack strength of activated energy line-hardening tackiness agent layers with respect to a silicon wafer.

[Measurement of Values of r/L]

Adhesive sheets obtained in the below-described working examples were cut to a size of 100 mm×100 mm. Then, each adhesive sheet, for which an activated energy line-hardening tackiness agent was used, was irradiated with an approximately 500 mJ/cm² dose of ultraviolet rays. One end of the adhesive sheet was immersed in 80° C. water along the axial direction of contraction of the shrinkable film, to facilitate transformation. For an adhesive sheet which transformed into a cylindrical roll, the diameter thereof was evaluated using a ruler. This value was divided by 100 mm to define the value as r/L. Note that laminated sheets having no tackiness agent layers exhibit the same behaviors as adhesive sheets having tackiness agent layers in regard to self-rolling properties.

### Manufacture of Tackiness Agent Layers

### Manufacturing Example 1

### Manufacture of Activated Energy Line-Hardening Tackiness Agent Layer (1)

50% of a hydroxyl group derived from 2-hydroxyethyl acrylate of an acrylic-based polymer [obtained by copolymerizing a material having a composition of 2-ethylhexyl acrylate:morpholyl acrylate:2-hydroxyethyl acrylate=75:25:22 (molar ratio)] was combined with methacryloyl oxyethyl isocyanate (2-isocyanatoethyl methacrylate) to manufacture an acrylic-based polymer having a methacrylate group in the side chain thereof.

15 pts. wt. of Aronix M320 (trimethylolpropane PO-modified (n≈2) triacrylate made by Toagosei), which is a photopolymerizable cross-linking agent, 1 pts. wt. of a photoinitiator (“IRGACURE” 651″ (trade name) made by Ciba-Geigy), and 1 pts. wt. of an isocyanate-based cross-linking agent (“CORONATE L” (trade name)) were blended with 100 pts. wt. of this acrylic-based polymer having a methacrylate group in the side chain thereof, to prepare an activated energy line-hardening tackiness agent.

The activated energy line-hardening tackiness agent thus obtained was coated on a separating sheet (made by Mitsubishi Polyester Film under the trade name “MRF38”) by using an applicator. After that, the volatile constituents of the tackiness agent, such as a solvent, were dried off, thereby obtaining a laminated body in which a 35 μm-thick activated energy line-hardening tackiness agent layer was provided on the separating sheet.

### Manufacturing Example 2

### Manufacture of Non-activated Energy Line-Hardening Tackiness Agent Layer (1)

0.7 pts. wt. of an epoxy-based cross-linking agent (made by Mitsubishi Gas Chemical Company under the trade name “TETRAD-C”), and 2 pts. wt. of an isocyanate-based cross-linking agent (“CORONATE L” (trade name)) were blended with a 100 pts. wt. of an acrylic-based copolymer [obtained by copolymerizing a material having the composition of butyl acrylate:acrylic acid=100:3 (weight %)] to prepare a non-activated energy line-hardening tackiness agent.

The non-activated energy line-hardening tackiness agent thus obtained was coated on a separating sheet (made by Mitsubishi Polyester Film under the trade name “MRF38”) by using an applicator. After that, the volatile constituents of the tackiness agent, such as a solvent, were dried off, thereby obtaining a laminated body in which a 30 μm-thick non-activated energy line-hardening tackiness agent layer was provided on the separating sheet.

### Manufacturing Example 3

### Manufacture of Activated Energy Line-Hardening Tackiness Agent Layer (2)

80% of a hydroxyl group derived from 2-hydroxyethyl acrylate of an acrylic-based polymer [obtained by copolymerizing a material having the composition of butyl acrylate: ethyl acrylate: 2-hydroxyethyl acrylate=50:50:20 (weight %)] was combined with methacryloyl oxyethyl isocyanate (2-isocyanatoethyl methacrylate) to manufacture an acrylic-based polymer having a methacrylate group in the side chain thereof.

100 pts. wt. of “SHIKOH UV1700” (trade name) made by The Nippon synthetic Chemical Industry Co., Ltd., which was used as a compound containing two or more functional groups having a carbon-carbon double bond, 3 pts. wt. of a photoinitiator (made by Ciba-Geigy under the trade name “IRGACURE 184”), and 1.5 pts. wt. of an isocyanate-based cross-linking agent (“CORONATE L” (trade name)) were blended with 100 pts. wt. of this acrylic-based polymer having a methacrylate group in the side chain thereof, to prepare an activated energy line-hardening tackiness agent.

The activated energy line-hardening tackiness agent thus obtained was coated on a separating sheet (made by Mitsubishi Polyester Film under the trade name “MRF38”) by using an applicator. After that, the volatile constituents of the tackiness agent, such as a solvent, were dried off, thereby obtaining a laminated body in which a 30 μm-thick activated energy line-hardening tackiness agent layer was provided on the separating sheet.

### Manufacturing Example 4

### Manufacture of Non-activated Energy Line-Hardening Tackiness Agent Layer (2)

0.7 pts. wt. of an epoxy-based cross-linking agent (made by Mitsubishi Gas Chemical Company under the trade name “TETRAD-C”), and 2 pts. wt. of an isocyanate-based cross-linking agent (“CORONATE L” (trade name)) were blended with a 100 pts. wt. of an acrylic-based copolymer [obtained by copolymerizing a material having a composition of butyl acrylate:acrylic acid=100:3 (weight %)], to prepare a non-activated energy line-hardening tackiness agent.

The non-activated energy line-hardening tackiness agent thus obtained was coated on a separating sheet (made by Mitsubishi Polyester Film under the trade name “MRF38”) by using an applicator. After that, the volatile constituents of the tackiness agent, such as a solvent, were dried off, thereby obtaining a laminated body in which a 30 μm-thick non-activated energy line-hardening tackiness agent layer was provided on the separating sheet.

### Reference Example 1

### Manufacture of Protection Tape Composed of Shrinkable Film Layer, Restriction Layer (Elastic Layer/Rigid Film Layer) and Activated Energy Line-Hardening Tackiness Agent

A solution prepared by blending and dissolving 100 pts. wt. of an ester-based polymer [obtained by copolymerizing a material having a composition of PLACCEL CD220PL (made by Daicel Chemical Industries):sebacic acid=100:10 (weight %)] and 4 pts. wt. of “CORONATE L” (cross-linking agent made by Nippon Polyurethane Industry) in ethyl acetate was coated on a non-easy printing-treated surface of a polyethylene terephthalate film (38 μm-thick PET film, “Lumirror S105” (trade name), a one-side easy printing-treated product made by TORAY INDUSTRIES, INC.) serving as a rigid film layer, and then dried, to form an elastic layer. A shrinkable film layer (30 μm-thick uniaxially-stretched polyester film, made by Toyobo under the trade name “SPACECLEAN S7053”) was stacked on the elastic layer and laminated using a hand roller, to obtain a laminated sheet (with an ester-based tackiness agent layer, 30 μm in thickness).

The activated energy line-hardening tackiness agent layer (1) side of the laminated body obtained in Manufacturing Example 1 was laminated on the rigid film layer side of the laminated sheet obtained as described above. The laminated body thus obtained was threaded through the laminator to make the layers have close contact with each other, thereby obtaining a protection tape composed of the shrinkable film layer, the restriction layer [elastic layer (ester-based tackiness agent layer), the rigid film layer (PET film layer)], the activated energy line-hardening tackiness agent (1) layer, and the separating sheet.

### <Consideration of Dicing Properties>

The separating sheet was separated off from the protection tape thus obtained, and the activated energy line-hardening tackiness agent (1) layer side of the protection tape was bonded to the mirror surface (front surface) of an 8-inch silicon mirror wafer by using a hand roller. After that, the wafer was ground by a wafer grinding apparatus (DFG8560 made by DISCO Corporation), so that the thickness of the wafer was 200 μm. Next, NBD2170K-X1 (made by Nitto Denko Corporation) was bonded as a dicing tape to the rear surface of the wafer, which was a ground surface. The wafer was in turn bonded to a dicing ring. After this, the wafer was subjected to single-cut dicing (the protection tape and the wafer were cut together at one time with a single blade) by a dicing apparatus (DFD651 made by DISCO Corporation), so as to be divided into 5 mm×5 mm individual pieces.

A wafer in which even a single cut-off piece was found to be cracked or broken, or cleaning water used during dicing was found to have seeped into a boundary face between the protection tape and the wafer, in visual inspection after the dicing was determined to be defective. Otherwise, the wafer was determined to be acceptable and, consequently, the dicing properties thereof were determined to be also acceptable.

### <Test of Peel Properties>

The 8-inch silicon mirror wafer fitted with the protection tape after the abovementioned dicing was exposed (at 500 mJ/cm² for 15 seconds) using a UV exposure machine with a high-pressure mercury lamp as the light source thereof. The wafer was then mounted on a 90° C. adsorption hot plate to conduct a peel test. After a lapse of one minute or so, the protection tape separated off on all of the diced individual pieces, while transforming into cylindrical rolls.

### <Collection and Removal of Protection Tape>

Next, the protection tape was collected and removed from the wafer divided into individual pieces. The protection tape was collected and removed in the below-described two ways:

(1) Work with Tweezers

The separating tape was pinched with tweezers, so as not to scratch a wafer surface, and the amount of time taken to separate off all portions of the protection tape was measured.

(2) Use of Separating Tape

A separating tape made by bonding a double-sided tape (N5000 made by Nitto Denko Corporation) to a polyethylene terephthalate film cut out to the same size as that of the 8-inch wafer was prepared. The separating tape was bonded to the protection tape by using a hand roller, so as not to bring the separating tape into contact with a wafer surface, to separate off the protection tape. Then, a measurement was made as to what percentage of the cut-off individual pieces of the protection tape was able to be collected by the separating tape.

As the result of protection tape collection, all pieces of the protection tape were able to be collected in 15 minutes in item (1), Work with Tweezers, as shown in Table 1. The individual pieces of the protection tape were found to have transformed into cylindrical rolls of almost the same shape. In addition, the cylindrical rolls had rigidity, and therefore, were easy to collect with tweezers. Likewise, 100% of the cylindrical rolls were able to be collected using a method based on in item (2), Use of Separating Tape, without any failure in the adhesion of the cylindrical rolls to the separating tape. This was because all of the cylindrical rolls were almost the same in height and had rigidity.

Note that the thermal contraction percentage of the abovementioned shrinkable film layer in the primary contraction direction thereof was 70% or higher at 100° C. Also note that the shear elastic modulus (80° C.) of an ester-based tackiness agent layer (elastic layer) was 2.88×10⁵ N/m², and a product of the shear elastic modulus and thickness thereof was 8.64 N/m. The tack strength (50° C.) of the ester-based tackiness agent layer (elastic layer) with respect to the shrinkable film layer was 13 N/10 mm.

In addition, the Young's modulus of the PET film layer (rigid film layer) at 80° C. was 3.72×10⁹ N/m² and a product of the Young's modulus and thickness thereof was 1.41×10⁵ N/m. The value of r/L was 0.06.

### Reference Example 2

### Manufacture of Protection Tape Composed of Shrinkable Film Layer, Restriction Layer (Elastic Layer/Rigid Film Layer) and Non-activated Energy Line-Hardening Tackiness Agent

A solution prepared by blending and dissolving 100 pts. wt. of an ester-based polymer [obtained by copolymerizing a material having a composition of PLACCEL CD220PL (made by Daicel Chemical Industries):sebacic acid=100:10 (weight %)] and 4 pts. wt. of “CORONATE L” (cross-linking agent made by Nippon Polyurethane Industry) in ethyl acetate was coated on a non-corona-treated surface of a polyethylene terephthalate film (38 μm-thick PET film, “Lumirror S105” (trade name), a one-side corona-treated product made by TORAY INDUSTRIES, INC.) serving as a rigid film layer, and then dried, to form an elastic layer. A shrinkable film layer (30 μm-thick uniaxially-stretched polyester film made by Toyobo Co., Ltd. under the trade name “SPACECLEAN S7053”) was stacked on the elastic layer and laminated using a hand roller, to obtain a laminated sheet (with an ester-based tackiness agent layer, 30 μm in thickness).

The non-activated energy line-hardening tackiness agent layer (1) side of the laminated body obtained in Manufacturing Example 2 was laminated on the rigid film layer side of the laminated sheet obtained as described above. The laminated body thus obtained was threaded through the laminator to make the layers have close contact with each other, thereby obtaining a protection tape composed of the shrinkable film layer, the restriction layer [elastic layer (ester-based tackiness agent layer), the rigid film layer (PET film layer)], the non-activated energy line-hardening tackiness agent (1) layer, and the separating sheet.

### <Consideration of Dicing Properties>

Using the protection tape thus obtained, the 8-inch silicon mirror wafer fitted with the protection tape was subjected to single-cut dicing in the same way as in Working Example 1. As the result of visually inspecting the 8-inch silicon mirror wafer fitted with the protection tape after the dicing in the same way as in Working Example 1, the dicing properties of the protection tape were determined to be acceptable.

### <Test of Peel Properties>

The 8-inch silicon mirror wafer fitted with the protection tape after the abovementioned dicing was mounted on a 90° C. adsorption hot plate to conduct a peel test. After a lapse of one minute or so, the protection tape separated off on all of the diced individual pieces, while transforming into cylindrical rolls.

### <Collection and Removal of Protection Tape>

Next, the protection tape was collected and removed from the top surface of the wafer divided into individual pieces, in the same way as in Reference Example 1, by using the collection methods of items (1) and (2).

As the result of protection tape collection, all pieces of the protection tape were able to be collected in 15 minutes in item (1), Work with Tweezers, as shown in Table 1. The individual pieces of the protection tape were found to have transformed into cylindrical rolls of almost the same shape. In addition, the cylindrical rolls had rigidity and had risen from the wafer, and therefore, were easy to collect with tweezers.

Likewise, 100% of the cylindrical rolls were able to be collected using a method based on in item (2), Use of Separating Tape, without any failure in the adhesion of the cylindrical rolls to the separating tape. This was because all of the cylindrical rolls were almost the same in height and had rigidity.

Note that the thermal contraction percentage of the abovementioned shrinkable film layer in the primary contraction direction thereof was 70% or higher at 100° C. Also note that the shear elastic modulus (80° C.) of an ester-based tackiness agent layer (elastic layer) was 2.88×10⁵ N/m², and a product of the shear elastic modulus and thickness thereof was 8.64 N/m. The tack strength (50° C.) of the ester-based tackiness agent layer (elastic layer) with respect to the shrinkable film layer was 13 N/10 mm.

In addition, the Young's modulus of the PET film layer (rigid film layer) at 80° C. was 3.72×10⁹ N/m², and a product of the Young's modulus and thickness thereof was 1.41×10⁵ N/m. The value of r/L was 0.06.

### Comparative Example 1

### Manufacture of Protection Tape Composed of Polyolefin Base Material and Activated Energy Line-Hardening Tackiness Agent Layer

The activated energy line-hardening tackiness agent layer (1) side of the laminated body obtained in Manufacturing Example 1 was laminated on TORAYFAN, a poly olefin type substrate (a two-side corona-treated product, 60 μm in thickness, made by TORAY INDUSTRIES, INC.). The laminated body thus obtained was threaded through the laminator to make the layers have close contact with each other, thereby obtaining a protection tape composed of the polyolefin base material, the UV-hardening tackiness agent, and the separating sheet.

### <Consideration of Dicing Properties>

Using the protection tape thus obtained, the 8-inch silicon mirror wafer fitted with the protection tape was subjected to single-cut dicing in the same way as in Working Example 1. As the result of visually inspecting the 8-inch silicon mirror wafer fitted with the protection tape after the dicing in the same way as in Working Example 1, the dicing properties of the protection tape were determined to be acceptable.

### <Test of Peel Properties>

The 8-inch silicon mirror wafer fitted with the protection tape after the abovementioned dicing was exposed (at 500 mJ/cm² for 15 seconds) using a UV exposure machine with a high-pressure mercury lamp as the light source thereof. The wafer was then mounted on a 90° C. adsorption hot plate to conduct a peel test. After a lapse of one minute or so, a slight degree of transformation into an indeterminate form took place on the diced individual pieces. No separation was observed visually, however.

### <Collection of Protection Tape>

Next, the protection tape was collected from the top surface of the wafer divided into individual pieces, in the same way as in Working Example 1, by using the collection methods of items (1) and (2).

As the result of protection tape collection, collection work was not completed even after one hour, and thus, involved extreme difficulty in item (1), Work with Tweezers, as shown in Table 1. The individual pieces of the protection tape were found to have transformed at random, respectively. In addition, the rise of the protection tape from the wafer was insufficient, and therefore, the tape was difficult to collect with tweezers.

Likewise, only 13% of the protection tape was able to be collected using a method based on in item (2), Use of Separating Tape. This was because only a slight degree of transformation into an indeterminate form took place in the tape, and therefore, adhesion of the protection tape to the separating tape was insufficient.

TABLE 1

| | | | Peel Properties (2) |
|---|---|---|---|
| | Dicing | Peel Properties (1) | Use of Separating |
| | Properties | Work with Tweezers | Tape |
| Reference | Acceptable | 15 min. | 100% |
| Example 1 | | | |
| Reference | Acceptable | 15 min. | 100% |
| Example 2 | | | |
| Comparative | Acceptable | Not completed even | 13% |
| Example 1 | | after one hour | |

### Working Example 1

### Manufacture of Protection Tape Composed of Shrinkable Film Layer, Restriction Layer (Elastic Layer/Rigid Film Layer) and Activated Energy Line-Hardening Tackiness Agent

A polymer solution prepared by dissolving 100 pts. wt. of an acrylic-based polymer (made by Daiichi Lace under the trade name “Rheocoat R1020S”), 10 pts. wt. of a pentaerythritol-modified acrylate cross-linking agent (made by Nippon Kayaku under the trade name “DPHA40H”), 0.25 pts. wt. of “TETRAD-C” (cross-linking agent made by Mitsubishi Gas Chemical Company), 2 pts. wt. of “CORONATE L” (cross-linking agent made by Nippon Polyurethane Industry), and 3 pts. wt. of “IRGACURE 651” (photoinitiator made by Ciba-Geigy) in methyl ethyl ketone was coated on one surface of a polyethylene terephthalate film (PET film, 38 μm in thickness, made by TORAY INDUSTRIES, INC. under the trade name “Lumirror S10”) serving as a rigid film layer, and then dried, to form an elastic layer. In addition, a shrinkable film layer (60 μm-thick uniaxially-stretched polyester film, made by Toyobo under the trade name “SPACECLEAN S5630”) was stacked on the elastic layer and laminated using a hand roller, to obtain a laminated sheet (with an acrylic-based tackiness agent layer, 30 μm in thickness).

The activated energy line-hardening tackiness agent layer (2) side of the laminated body composed of the activated energy line-hardening tackiness agent layer (2) and the separating sheet obtained in Manufacturing Example 3 was laminated on the rigid film layer side of the laminated sheet obtained as described above.

The laminated body thus obtained was threaded through the laminator to make the layers have close contact with each other, thereby obtaining a protection tape composed of the shrinkable film layer, the restriction layer [acrylic-based tackiness agent layer (elastic layer), the PET film layer (a rigid film layer)], the activated energy line-hardening tackiness agent (1) layer, and the separating sheet.

### Working Example 2

### Manufacture of Protection Tape Composed of Shrinkable Film Layer, Restriction Layer (Elastic Layer/Rigid Film Layer), and Non-Activated Energy Line-Hardening Tackiness Agent (2)

A protection tape was obtained in the same way as in Working Example 1, except that in Working Example 1, the activated energy line-hardening tackiness agent layer (2) was changed to the non-activated energy line-hardening tackiness agent layer (2) obtained in Manufacturing Example 4.

Note that in Working Examples 1 and 2, the thermal contraction percentage of the abovementioned heat-shrinkable film layer in the primary contraction direction thereof was 70% or higher at 100° C. Also note that the shear elastic modulus (80° C.) of the acrylic-based tackiness agent layer (elastic layer) was 0.72×10⁶ N/m², and a product of the shear elastic modulus and thickness thereof was 21.6 N/m. The tack strength (50° C.) of the acrylic-based tackiness agent layer (elastic layer) with respect to the shrinkable film layer was 4.4 N/10 mm. In addition, the Young's modulus of the PET film layer (rigid film layer) at 80° C. was 3.72×10⁹ N/m² and a product of the Young's modulus and thickness thereof was 1.41×10⁵ N/m. The value of r/L was 0.045.

### Comparative Example 2

An easy adhesion-treated surface side of a polyethylene terephthalate film (PET film, 50 μm in thickness, made by TORAY INDUSTRIES, INC. under the trade name “Lumirror S105”) was laminated on the activated energy line-hardening tackiness agent layer (2) side of the laminated body obtained in Manufacturing Example 3. The laminated body thus obtained was threaded through the laminator to make the layers have close contact with each other, thereby obtaining a protection tape composed of the base material film layer, the activated energy line-hardening tackiness agent layer, and the separating sheet.

### Comparative Example 3

A protection tape was obtained, which was similar to the one described in Comparative Example 2 except that in Comparative Example 2, the activated energy line-hardening tackiness agent layer (2) was changed to the non-activated energy line-hardening tackiness agent layer (2) obtained in Manufacturing Example 4.

### Comparative Example 4

A protection tape was obtained, which was similar to the one described in Comparative Example 2 except that in Comparative Example 2, the polyethylene terephthalate film was changed to one obtained by subjecting a 100 μm-thick film, which was formed by extrusion-molding an ethylene-vinyl acetate copolymer (“EVAFLEX P1007” made by Du Pont-Mitsui Polychemicals), to easy adhesion treatment by means of corona treatment.

### Comparative Example 5

A protection tape was obtained, which was similar to the one described in Comparative Example 1 except that in Comparative Example 2, the polyethylene terephthalate film was changed to one obtained by subjecting a 100 μm-thick film, which was formed by extrusion-molding low-molecular polyethylene, to easy adhesion treatment by means of corona treatment.

### <Back-grinding Process>

The protection tapes obtained in Working Examples 1 and 2 and Comparative Examples 2 to 5 were bonded to 8-inch silicon mirror wafers by using a hand roller. Then, the wafers were back-ground under the below-described conditions, thereby obtaining laminated bodies comprised of silicon wafers and protection tapes and having a predetermined thickness.

### Back-Grinding Conditions

Apparatus: “DFG-8560” (trade name) made by DISCO

### Corporation

Z1 wheel: “GF-01-SD360-VS-100” (trade name) with #360 abrasive grain, made by DISCO Corporation

Z2 wheel: “BGT2701F-01-1-4/6-B-K09” (trade name) with #2000 abrasive grain, made by DISCO Corporation

Z2 grinding amount: 50 μm

Finished wafer thickness: 250 μm

### <Dicing Tape Bonding Process>

A dicing tape (NBD-2170K-X1 made by Nitta Denko) was bonded to a surface (on the silicon wafer side), opposite to the protection tape, of each of laminated bodies comprised of the silicon wafers obtained in the back-grinding process and the protection tapes of Working Examples 1 and 2 and Comparative Examples 3 to 6, by using a hand roller. Thus, specimens for dicing were obtained for the respective laminated bodies.

### <Dicing Process>

Dicing was performed, under the below-described conditions, on each dicing specimen obtained in the dicing tape bonding process to change the specimen into chip forms, thereby obtaining chip-laden workpieces.

Dicing conditions:

Apparatus: “DFD-651” (trade name) made by DISCO

Dicing blade: NBC-ZH205O-27HEEE made by DISCO

Dicing speed: 80 mm/sec

Blade rotational speed: 40000 rpm

Blade height: 50 μm

Cutting water feed rate: 1 L/min

Chip size: 10 mm×10 mm

### <Ultraviolet Irradiation to Protection Tapes>

Next, ultraviolet rays were irradiated under the below-described conditions from the protection tape side for specimens using the protection tapes of Working Example 1 and Comparative Examples 2, 4 and 5 in which an activated energy line-hardening tackiness agent layer was used.

Ultraviolet irradiation conditions:

Apparatus: “NEL UM-810” (trade name) made by Nitto Seiki

Ultraviolet irradiance: 20 mW/cm²

Ultraviolet light quantity: 1000 mJ/cm²

### <Heating and Removal of Protection Tape>

(1) Removal of Protection Tape by Hot Wind

Each of the workpieces obtained as described above and fitted with chips, to which the protection tapes obtained in Working Examples 1 and 2 and Comparative Examples 2 to 5 were bonded, was mounted and adsorbed onto a hot plate, so that the dicing tape side of the workpiece had contact therewith. As the hot plate, a hot plate having an adsorption mechanism with the surface temperature thereof set to 60° C. was used.

Next, hot wind was applied for 3 minutes at an angle of 45° from the protection tape side by using a dryer (Plajet PJ214A made by Ishizaki Electric MFG), so that the surface temperature of the protection tape was 80° C.

After that, the hot wind was stopped, the chip-laden workpiece was removed from the hot plate, and the number of successfully separated-off pieces of the protection tape was counted visually. A value obtained by dividing [number of successfully separated-off pieces] by [number of all chips on chip-laden workpiece] was defined as the rate of successful protection tape removal by hot wind. There is no substantial difference in adhesive force between chips and pieces of the protection tape when the chip-laden workpiece is placed level and when the chip-laden workpiece is placed at an angle, for example, upright or upside down. Accordingly, the resulting rate of successful removal when the protection tape is removed with the chip-laden workpiece placed at an angle, for example, upright or upside down, can be verified on the basis of results regarding the rate of successful removal of protection tapes tested with chip-laden workpieces placed level, as in the working examples.

(2) Removal of Protection Tape by Separating Tape

Each of the workpieces obtained as described above and fitted with chips, to which the protection tapes obtained in Working Examples 1 and 2 and Comparative Examples 2 to 5 were bonded, was mounted and adsorbed onto a hot plate, so that the dicing tape side of the workpiece had contact therewith. As the hot plate, a hot plate having an adsorption mechanism with the surface temperature thereof set to 60° C. was used.

Next, the temperature of the hot plate was controlled, so that the surface temperature of the protection tape was 80° C. Then, the workpiece was allowed to stand for 3 minutes. After that, a separating tape (made by Nitto Denko under the trade name “ELP BT-315”) was bonded to a surface of the protection tape by using a hand roller, 230 mm in width and approximately 4 Kg in weight. After allowing the workpiece to stand still for 30 seconds, the separating tape was peeled off at a peel angle of approximately 120° and a peeling-point moving speed of 300 mm/min.

Thereafter, the chip-laden workpiece was removed from the hot plate and the number of successfully separated-off pieces of the protection tape was counted visually. A value obtained by dividing [number of successfully separated-off pieces] by [number of all chips on chip-laden workpiece] was defined as the rate of successful protection tape removal by a separating tape.

Table 2 shows the results of protection tape removal tests conducted in Working Examples 1 and 2 and Comparative Examples 2 to 5. In every test conducted in Comparative Examples 2 to 5, it was difficult to obtain a trigger for separation, and therefore, the rate of protection tape removal was low. In tests conducted in Working Examples 1 and 2, it was possible to completely remove protection tapes. In addition, judging from these results, it is fully understandable to those skilled in the art that a protection tape can be reliably removed even if a chip-laden workpiece is inclined at the time of protection tape removal in Working Examples 1 and 2.

TABLE 2

| | | | Rate of | Rate of |
|---|---|---|---|---|
| | Tackiness | | protection tape | protection tape |
| | agent | Base | removal by | removal by |
| | layer | material | hot wind | separating tape |
| Working | UV | Self-rollable | 100% | 100% |
| Example 1 | | material | | |
| Working | PSA | Self-rollable | 100% | 100% |
| Example 2 | | material | | |
| Comparative | UV | PET | 5% | 30% |
| Example 2 | | | | |
| Comparative | PSA | PET | 0% | 5% |
| Example 3 | | | | |
| Comparative | UV | EVA | 0% | 10% |
| Example 4 | | | | |
| Comparative | UV | PE | 3% | 20% |
| Example 5 | | | | |

### DESCRIPTION OF SYMBOLS

1: Surface protection tape
1′: Surface protection tape after transformation by application of contraction-inducing stimulus, such as heating
10 to 15: Laminated body as one example of surface protection tape
2: Shrinkable film layer
3: Restriction layer
31: Elastic layer
32: Rigid film layer
33: Activated energy line-hardening tackiness agent layer
4: Tackiness agent layer
5: Peeling liner
6: Intermediate layer
7: Adherend, such as wafer
8: Dicing tape
9: Specimen for dicing
19: Dicing ring
101: Surface protection tape as conventional example
101′: Surface protection tape as conventional example after thermal transformation
109: Specimen for dicing as conventional example

What is claimed is:

1. A method for separating and removing a dicing surface protection tape from an object to be cut, wherein the dicing surface protection tape which develops easy peeling properties by stimulation is bonded to one surface of the object to be cut to form a composite body, and then the composite body is positioned so that the dicing surface protection tape side faces up, the object to be cut is cut from the dicing surface protection tape side and, subsequently, A. a step of applying a stimulus to the dicing surface protection tape to cause the tape to develop easy peeling properties, B. a step of inclining the composite body at an arbitrary angle up to an angle for the composite body to turn over, and C. a step of separating and removing only the cut-off portions of the dicing surface protection tape from the composite body, are carried out in the order of steps A to C, or in the order of steps B, A and C, or steps A and C are simultaneously carried out after step B.

2. A method for separating and removing a dicing surface protection tape from an object to be cut, wherein the dicing surface protection tape which develops easy peeling properties by stimulation is bonded to one surface of the object to be cut to form a composite body, and then the composite body is positioned so that the dicing surface protection tape side faces down, the object to be cut is cut from the dicing surface protection tape side, and, subsequently, A. a step of applying a stimulus to the dicing surface protection tape to cause the tape to develop easy peeling properties, and C. a step of separating and removing only the cut-off portions of the dicing surface protection tape from the composite body, are carried out in the order of steps A and C, or steps A and C are simultaneously carried out.

3. The method according to claim 1, wherein the step B is carried out using a robot arm, a rotational axis provided in a composite body-retaining apparatus, or a reversing apparatus for sheet-like objects.

4. The method according to claim 1, wherein the stimulus for the dicing surface protection tape to develop easy peeling properties is heat, ultraviolet rays, or electromagnetic waves.

5. The method according to claim 2, wherein the stimulus for the dicing surface protection tape to develop easy peeling properties is heat, ultraviolet rays, or electromagnetic waves.

6. The method according to claim 3, wherein the stimulus for the dicing surface protection tape to develop easy peeling properties is heat, ultraviolet rays, or electromagnetic waves.

7. The method according to claim 1, wherein the means for separating and removing the protection tape is means for suctioning the tape by a difference in atmospheric pressure.

8. The method according to claim 2, wherein the means for separating and removing the protection tape is means for suctioning the tape by a difference in atmospheric pressure.

9. The method according to claim 1, wherein the means for separating and removing the protection tape is means for blowing off the tape by a difference in atmospheric pressure.

10. The method according to claim 2, wherein the means for separating and removing the protection tape is means for blowing off the tape by a difference in atmospheric pressure.

11. The method according to claim 9, wherein the means for blowing off the tape by a difference in atmospheric pressure is means using a heated gas.

12. The method according to claim 10, wherein the means for blowing off the tape by a difference in atmospheric pressure is means using a heated gas.

13. The method according to claim 1, wherein the means for separating and removing the protection tape is means concomitantly using means for applying vibrations from the rear surface of the object to be cut.

14. The method according to claim 2, wherein the means for separating and removing the protection tape is means concomitantly using means for applying vibrations from the rear surface of the object to be cut.

15. The method according to claim 1, wherein the means for separating and removing the protection tape is means for causing the protection tape to be adsorbed to an electrified object by electrostatic force.

16. The method according to claim 2, wherein the means for separating and removing the protection tape is means for causing the protection tape to be adsorbed to an electrified object by electrostatic force.

17. The method according to claim 1, wherein the dicing surface protection tape which develops easy peeling properties by stimulation is one of dicing surface protection tapes which have easy peeling properties such that each of the tapes contracts by stimulation, a foaming agent-containing adhesive agent layer of the tape foams, or the tape curls up by stimulation.

18. The method according to claim 2, wherein the dicing surface protection tape which develops easy peeling properties by stimulation is one of dicing surface protection tapes which have easy peeling properties such that each of the tapes contracts by stimulation, a foaming agent-containing adhesive agent layer of the tape foams, or the tape curls up by stimulation.

19. The method according to claim 1, wherein the object to be cut is one of a semiconductor wafer, a glass plate, and a resin plate.

20. The method according to claim 2, wherein the object to be cut is one of a semiconductor wafer, a glass plate, and a resin plate.
